(19) United States
(12) Patent Application Publication
(10) Pub. No.: US 2015/0193646 A1
(43) Pub. Date: Jul. 9, 2015

(54) Read-in Device, Read-in Result Output Method, and Medium

(71) Applicant: Optoelectronics Co., Ltd., Saitama (JP)

(72) Inventor: Takashi Ushiki, Saitama (JP)

(21) Appl. No.: 14/556,167

(22) Filed: Nov. 30, 2014

Related U.S. Application Data
(63) Continuation of application No. PCT/JP2012/064057, filed on May 31, 2012.

(51) Int. Cl. G06K 7/14

(52) U.S. Cl. CPC G06K 7/1439

(57) ABSTRACT

Plural input formats of information are set in advance, information in a read-in area is read as input information, and from input information which matches one of the set input formats among the read input information, information of one or more items extracted based on the input format is registered as a read-in result of the one or more items in a read-in result table. When read-in results for all necessary items are registered in the read-in result table, the registered read-in results are read and outputted to a predetermined output destination device.

### CROSS-REFERENCE TO RELATED APPLICATION

This application is a Continuation of International Application No. PCT/JP2012/064057, filed on May 31, 2012, the entire disclosure of which is incorporated herein by reference.

### FIELD OF THE INVENTION

The invention relates to a read-in device and a read-in result output method to read information in a read-in area as input information and output a read-in result thereof, and relates to a non-transitory machine-readable medium containing program instructions for enabling a computer to control such a read-in device.

### BACKGROUND ART

It has been conventionally known a read-in device which reads an image of a code symbol such as a barcode or a two-dimensional code, and outputs a read-in result thereof to an external device such as a computer. In such a read-in device, it has been also known a technique of reading plural code symbols as illustrated in FIG. 38 at once and outputting read-in results thereof at once.

As a document related to such a technique, for example, there is PTL1 below.

### CITATION LIST

### Patent Literature

{PTL1} JP 4058478 B2

### SUMMARY OF THE INVENTION

### Technical Problem

Incidentally, in the conventionally known technique of reading at once, in order to output read-in results correctly, it has been necessary to fit all the codes as read-in targets at once in a read-in area, as indicated by a symbol X in FIG. 38. This is because when an image of taking the read-in area is decoded, decoding results are discarded as read-in errors if the read-in results are not obtained correctly for all the codes which are set in advance.

Therefore, as indicated by a symbol Y and a symbol Z in FIG. 38, when only part of the code symbols as read-in targets can be fit within the read-in area, it has not been possible to obtain an output of the read-in results.

However, even when a hand-held read-in device has an aiming function for example, the read-in device needs to be operated carefully to adjust a direction and a distance to target objects so that all the target code symbols fit within the read-in area thereof Therefore, there has been a problem of causing decrease in operating efficiency.

Further, when the read-in target objects move in the read-in area in a stationary-type read-in device, there is a problem of difficulty in timing adjustment for allowing imaging at a timing when all the target code symbols fit within the read-in area. When the read-in area is enlarged or an imaging frequency is increased for addressing this problem, there has also been a problem of leading to increase in decode processing load by that amount.

Such problems similarly occur when the information to be read is other than code symbols.

The present invention is made in view of such a background, and it is an object thereof to allow, in the case where information in a read-in area is read as input information and read-in results thereof are outputted, easily outputting read-in results of plural items even when the read-in area is relatively small and it is difficult to fit therein all the information desired to be read at once.

### Solution to the Problem

To attain the above object, a read-in device of the invention includes: a reader configured to read information in a read-in area as input information; an input setter configured to set input formats of information; a registrator configured to register information of one or more items extracted from input information which matches one of the input formats set by the input setter among the input information read by the reader, based on the one input format, as a read-in result of the one or more items in a predetermined memory, the registrator registering information of an item for which any read-in result is not registered in the memory, among the extracted information, additively to a read-in result which has been already registered; and a controller configured to perform control to repeat the reading by the reader and the registering by the registrator until the read-in result is registered for all necessary items; and a first outputter configured to read, when read-in results for all the necessary items are registered in the memory, the registered read-in results from the memory and output the read read-in results to a predetermined output destination device.

In such a read-in device, it is conceivable that the read-in device includes: an output setter configured to set an output format of the read-in results by the first outputter; and an output item identifier configured to identify, based on the output format set by the output setter, what items of the registered read-in result the first outputter outputs and which of the items is a necessary item, and that the first outputter is configured to output read-in results of the items identified by the output item identifier among the read-in results registered in the memory, as information of a format according to the output format set by the output setter.

Further, it is conceivable that the registrator is configured to register the information extracted from the input information with identification information specified based on the input format item-by-item.

Further, it is conceivable that the input information is decoding results of an arbitrary number of code symbols in the read-in area; the read-in device further comprises a first algorithm generator configured to generate a first algorithm for extracting one or more items of information from decoding result of one code symbol based on the input format set by the input setter; and the registrator is configured to extract the one or more items of information from the input information by commonly applying the first algorithm to the decoding result of each of the code symbols included in the input information.

Further, it is conceivable that the read-in device includes a second algorithm generator configured to generate a second algorithm for generating, based on the output format set by the output setter, information complying with the output format from the read-in results of items identified by the output item identifier, and the first outputter is configured to generate the information to be outputted to the predetermined output destination device according to the second algorithm.

Furthermore, it is conceivable that the read-in device includes a securer configured to secure a predetermined storage area in the memory for storing identification information of an item and the read-in result of the item corresponded with each other as a registration destination of the read-in result by the registrator, irrespective of settings of the input format and the output format, and that output item identifier identifies the items for which the first outputter outputs the registered read-in result and the necessary item by the identification information of the items included in the output format, and the first outputter is configured to read, for the outputting, the read-in result of the item indicated by the identification information identified by the output item identifier, from the predetermined storage area.

Further, it is conceivable that the read-in device includes a notifier configured to perform, every time the registrator newly registers a read-in result regarding an item for which a read-in result is not registered in the memory yet, a notification of the registration.

Further, it is conceivable that the read-in device includes a second outputter configured to output, when the input information read by the reader does not match any of the input formats set by the input setter, the input information to the predetermined output destination device.

Further, it is conceivable that the input setter includes a setter configured to set the input formats based on externally inputted information.

Further, it is conceivable that the output setter includes a setter configured to set the output format based on externally inputted information.

The invention can be realized also as system, method, program, medium, or other arbitrary manner other than the above described device.

### Advantageous Effects of the Invention

By a read-in device of the invention as described above, it is possible to allow, in the case where information in a read-in area is read as input information and read-in results thereof are outputted, easily outputting read-in results of plural items even when the read-in area is relatively small and it is difficult to fit therein all the information desired to be read at once.

### BRIEF DESCRIPTION OF THE DRAWINGS

FIG. 1 is a diagram illustrating a schematic hardware structure of one embodiment of a read-in device of the invention.

FIG. 2 is a diagram for explaining a read-in area in the read-in device.

FIG. 3 is a flowchart of processing for outputting read-in results executed by a CPU of the control circuit illustrated in FIG. 1.

FIG. 4 is a diagram illustrating an example of a read-in result table.

FIG. 5 is a diagram illustrating an example of code symbols to be read in a first example.

FIG. 6 is a diagram illustrating input formats used in the first example.

FIG. 7 is a diagram illustrating another description example of an input format illustrated in FIG. 6.

FIG. 8 is a diagram illustrating an example of verification processing corresponding to an input format with ID=0 in the first example.

FIG. 9 is a diagram likewise illustrating an example of verification processing corresponding to an input format with ID=1.

FIG. 10 is a diagram illustrating a registration example of read-in results in the read-in result table in the first example.

FIG. 11 is a diagram illustrating another example thereof.

FIG. 12 is a diagram illustrating an output format used in the first example.

FIG. 13 is a diagram illustrating an example of registration judgment processing in the case where the output format illustrated in FIG. 12 is set.

FIG. 14 is a diagram likewise illustrating an example of output data generation processing.

FIG. 15 is a diagram illustrating an example of output data generated by the processing of FIG. 14.

FIG. 16 is a diagram illustrating an example of a code symbol read in a second example.

FIG. 17 is a diagram illustrating an input format used in the second example.

FIG. 18 is a diagram illustrating an example of the verification processing corresponding to the input format illustrated in FIG. 17.

FIG. 19 is a diagram illustrating a registration example of read-in results in the read-in result table in the second example.

FIG. 20 is a diagram illustrating an output format used in the second example.

FIG. 21 is a diagram illustrating an example of output data generated by processing of FIG. 20.

FIG. 22A is a diagram illustrating an example of a code symbol read in a third example.

FIG. 22B is a diagram illustrating another example thereof.

FIG. 22C is a diagram illustrating still another example thereof.

FIG. 23 is a diagram illustrating an example of a table illustrating a description format of information using an application identifier.

FIG. 24 is a diagram illustrating input formats used in the third example.

FIG. 25 is a diagram illustrating an example of the verification processing corresponding to an input format with ID=2 in the third example.

FIG. 26 is a diagram illustrating a registration example of read-in results in the read-in result table in the third example.

FIG. 27 is a diagram illustrating another example thereof.

FIG. 28 is a diagram illustrating an output format used in the third example.

FIG. 29 is a diagram illustrating an example of the registration judgment processing in the case where the output format illustrated in FIG. 28 is set.

FIG. 30 is a diagram likewise illustrating an example of the output data generation processing.

FIG. 31 is a diagram illustrating an example of output data generated by processing of FIG. 30.

FIG. 32 is a diagram illustrating an input format used in a fourth example.

FIG. 33 is a diagram illustrating an example of the verification processing corresponding to the input format illustrated in FIG. 32.

FIG. 34 is a diagram illustrating a registration example of read-in results in the read-in result table in the fourth example.

FIG. 35 is a diagram illustrating another example thereof.

FIG. 36 is a diagram illustrating an output format used in the fourth example.

FIG. 37 is a diagram illustrating another example thereof.

FIG. 38 is a diagram for describing problems of a conventional batch reading.

### DETAILED DESCRIPTION

Hereinafter, embodiments for carrying out the invention will be described specifically based on drawings.

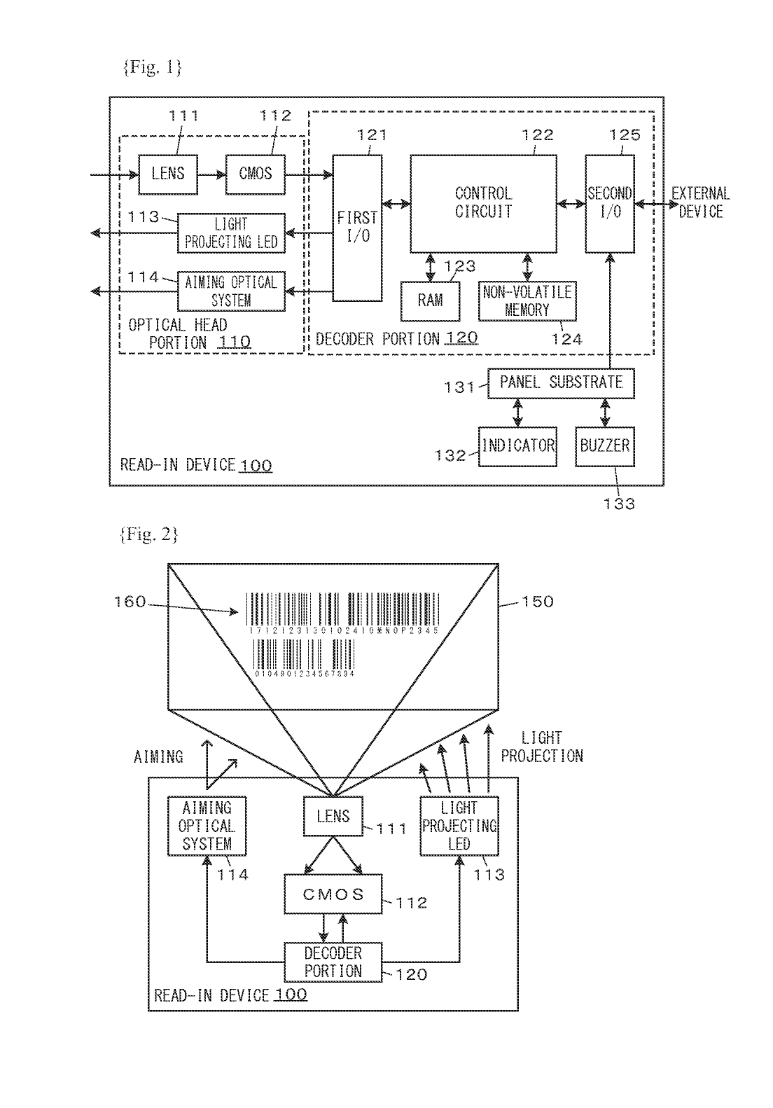

First, FIG. 1 illustrates a schematic hardware structure of one embodiment of a read-in device of the invention.

This read-in device 100 is a device reading a code symbol provided on a read-in target object and having modules arrayed therein with different light reflectivity from surroundings, and has an optical head portion 110, a decoder portion 120, a panel substrate 131, an indicator 132, and a buzzer 133. In addition to them, an operating portion such as buttons for accepting an operation by a user is also provided, but an illustration thereof is omitted. Note that shape of the code symbol is arbitrary, and any form of code can be read according to setting of the decoder portion 120, such as one-dimensional barcode, two-dimensional barcode, QR code (registered trademark, the same applies below), or the like.

Further, the optical head portion 110 has a lens 111, a CMOS (Complementary Metal Oxide Semiconductor) image sensor (hereinafter simply referred to as CMOS) 112 as one example of a solid-state image sensor, a light projecting LED (light emitting diode) 113 and an aiming optical system 114.

The lens 111 is an optical lens for example, and is for taking an image of a read-in target object into the optical head portion 110 and forming an image thereof on an imaging area of the CMOS 112.

The CMOS 112 images a read-in target object by reflected light from the read-in target object (assumed to include a code symbol) taken in by the lens 111, and generates image data expressed by digital luminance values from an analog image signal obtained by this imaging and outputs the image data to the decoder portion 120.

The light projecting LED 113 is an illuminator for illuminating the read-in target object with irradiated light to allow imaging of a clear image by the CMOS 112. However, the LED 113 may be omitted depending on the structure of the device.

The aiming optical system 114 is an irradiator displaying, by irradiation of light to the read-in target object, a mark of a range which can be imaged by the CMOS 112, that is, a read-in area of code symbols. Specifically, it irradiates the center, corners, surroundings, and/or the like of the read-in area with beams of visible light, or scans these positions with beams.

Note that the read-in area of the read-in device 100 is a range within which reflected light from the read-in target object can be imaged within the imaging area of the CMOS 112, which spreads about an optical axis of the lens 111 as illustrated schematically with a symbol 150 in FIG. 2. When a code symbol 160 desired to be read fits within this read-in area, an image thereof can be decoded and read.

The size of the read-in area varies depending on a distance from the read-in device 100 to the read-in target object and a relative direction, and/or the like.

Next, the decoder portion 120 has a first input/output interface (first I/O) 121, a control circuit 122, a RAM 123, a non-volatile memory 124, and a second input/output interface (second I/O) 125.

Among them, the first I/O 121 is an interface for transmitting/receiving a control signal, image data outputted by the CMOS 112, and the like between the optical head portion 110 and the decoder portion 120.

The control circuit 122 controls the CMOS 112 and the LED 113, and performs: filtering for removing noise; a data processing for decode preparation; decoding of code symbols based on image data after the processing; storing, processing and outputting of read-in results after decoding; and so on, with respect to image data of the read-in target object inputted from the CMOS 112 via the first I/O 121. Hardware thereof can be constituted of ASIC (Application Specific Integrated Circuit) and/or CPU. Note that, as details of the decode processing, a publicly known arbitrary method may be employed, such as the method described in JP 2005-25417 A for example. Further, the storing, processing and outputting of read-in results after decoding is a processing related to characteristics of this embodiment, and the details of this processing will be described later.

The RAM 123 is a memory which temporarily stores image data inputted from the CMOS 112, is used as a work memory during the data processing for decode preparation, temporarily stores the read-in results after decoding, and stores other data to be dynamically changed such as necessary data for operation of the read-in device 100. Part of the RAM 123 may be non-volatile.

The non-volatile memory 124 is a non-volatile memory storing a program for activating the read-in device 100, a program to be executed by the CPU of the control circuit 122, and the like. Further, in the read-in device 100, algorithm related to the storing, processing and outputting of read-in results after decoding can be set arbitrarily by the user, and this setting is also stored in the non-volatile memory 124.

The second I/O 125 is an interface for performing data communication with an external device such as a not-illustrated host computer, and read-in results after decoding and processing by the control circuit 122 can be outputted to the external device via the second I/O 125. There is also provided an interface for transmitting a control signal from the control circuit 122 to the panel substrate 131.

The panel substrate 131 is a substrate for controlling an operation panel (not necessarily in a panel form) to be a user interface of the read-in device 100.

The indicator 132 is a display for visually notifying an operating state of the read-in device 100 to the user by an LED lamp and/or the like based on control by the control circuit 122.

The buzzer 133 is an audio outputter for notifying the user of an operating state of the read-in device 100 by sound based on control by the control circuit 122.

Next, in the read-in device 100 having the above-described structure, a processing executed by the CPU of the control circuit 122 for outputting read-in results will be described.

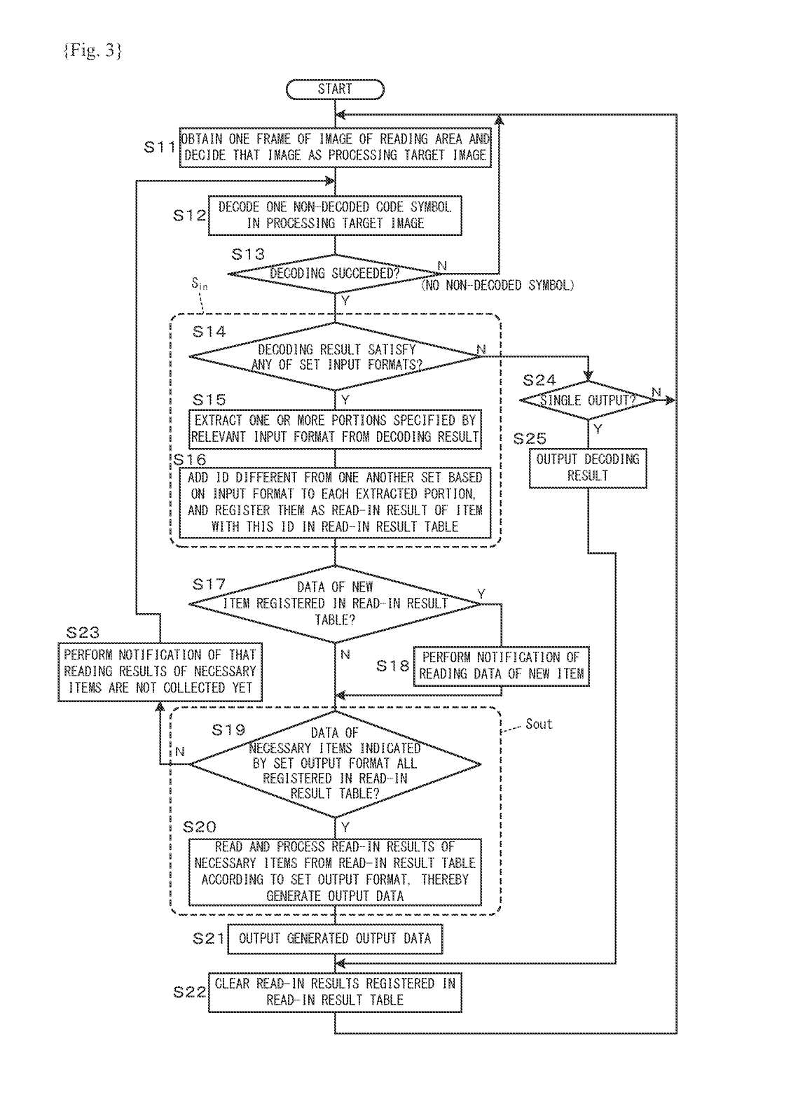

FIG. 3 is a flowchart of the processing for outputting read-in results executed by the CPU of the control circuit 122. This processing is to be executed mainly for a batch output which is to output read-in results of plural items at once.

The CPU of the control circuit 122 starts the processing illustrated in the flowchart of FIG. 3 when a start of reading a code symbol is instructed by a signal from the external device, an operation of the user, or the like.

Then the CPU first obtains an image of one frame obtained by the CMOS 112 imaging the read-in area, and decides the image as a processing target image (S11). Next, the CPU decodes one not-decoded code symbol in the processing target image (S12). As the method of this decoding, a publicly known method may be employed appropriately as described above. Further, when plural code symbols are included in the processing target image, the order of decoding among them is arbitrary. That is, the order may be set automatically, such as decoding sequentially from one found first in a search in the image.

When the decoding in step S12 is succeeded (Yes in S13), the CPU proceeds to a processing of step S14 and thereafter (input processing Sᵢₙ) so as to perform a processing related to registration of read-in result based on the decoding result.

In the processing of this part, first, the CPU judges whether the decoding result satisfies any of set input formats or not (S14). The input formats are as described in FIG. 6 for example and are set for outputting read-in results of plural items at once, but this point will be described later.

Then, when it is Yes in step S14, the CPU extracts one or more portions specified by the relevant input format from the decoding result (S15), adds an ID different from each other set based on the input format to each extracted portion, and then registers the each portion as a read-in result of an item with this ID in a read-in result table (S16). The read-in result table is as illustrated in FIG. 4 for example, and the data and IDs thereof will be described later.

Note that the extraction processing of step S15, the registration processing of step S16, and the judgment of step S14 may be performed as separate processings, but may also be combined and performed as one process. For example, regarding a character string of the decoding result, the CPU performs processing of extracting a predetermined part according to algorithm indicated by setting of the input format sequentially from the head and registering the extracted part in the read-in result table after it is processed as necessary, and when this is finished normally to the end, the CPU judges that the decoding result satisfied the input format. When the input format is not satisfied, at a point it becomes clear, the character string which has been registered up to this point in the read-in result table may be deleted.

Also in this manner, similar results to the case where the processings are performed separately can be obtained.

Note that when it is No in step S14, the CPU of the control circuit 122 judges that the code symbol decoded this time is not a target of the batch output. Then, the CPU judges whether or not performing a single output is set in this case (S24). If the single output is set, the CPU outputs the decoding result from the second I/O 125 to the external device which is a connection destination (S25). Thereafter, the CPU clears the read-in results registered in the read-in result table (S22), and returns to step S11 to repeat the processing.

By this processing, for any code symbol which is not a target of the batch output, a read-in result can be outputted as it is without switching the operating mode in particular, and in this point high operability can be obtained.

Further, when it is No in step S24, the CPU returns to step S11 to repeat the processing, so as to continue the processing related to the batch output.

On the other hand, after step S16, the CPU of the control circuit 122 judges whether or not data of a new item are registered in the read-in result table (S17). Then, when it is Yes, the CPU notifies a predetermined notification destination of the reading of the data of a new item (S18). As a method of the notification, when the notification destination is the user, generating a confirmation sound by a not-illustrated speaker provided in the read-in device 100 or lighting or blinking of a not-illustrated lamp is conceivable. Further, when the notification destination is a device, transmitting predetermined data to this device is conceivable.

Note that in the judgment of step S17, Yes may be judged also when a value different from previous one is registered in an item in which a read-in result has been registered already.

When it is No in step S17 or after the notification in step S18 is performed, the CPU proceeds to processing from step S19 (output processing Sₒᵤₜ) related to an output of read-in results.

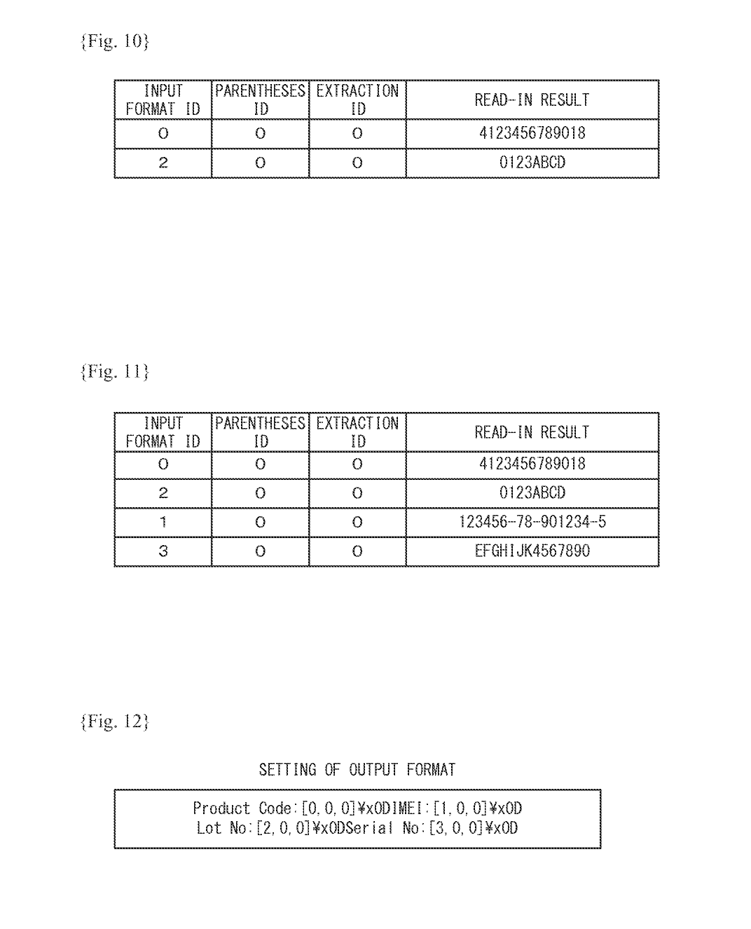

In the processing of this part, the CPU of the control circuit 122 first judges whether or not data of necessary items indicated by a set output format are all registered in the read-in result table (S19). The output format is as illustrated in FIG. 12 for example and is set for performing the batch output of read-in results of plural items, but this point will be described later.

Then, when it is Yes in step S19, the CPU reads the read-in results of necessary items from the read-in result table and processes the read results according to the set output format, to thereby generate output data (S20). Thereafter, the CPU outputs the generated output data from the second I/O 125 to the external device which is a connection destination (S21).

Thus, the series of processings related to the batch output of read-in results of plural items is completed. Then, in order to perform the processing related to the next output, the CPU clears the read-in results registered in the read-in result table (S22), and returns to step S11 to repeat the processing.

Further, when it is No in step S19, the CPU notifies the predetermined notification destination of the matter that read-in results of necessary items have not collected yet (S23). The method of the notification may be similar to the case of step S18. It may also be performed simultaneously as the notification in step S18, or one notification which means both the notifications may be given.

After step S23, the CPU returns to step S12 to repeat the processing. In this case, when there is a non-decoded code symbol in the same processing target image, this symbol is decoded consequently. Further, when such a code symbol does not exist, it is No in step S13, the CPU returns to step S11, obtains the image of the next frame and decides it as a processing target, and repeats the processing.

In the above processing, through steps S14 to S16, the CPU of the control circuit 122 functions as a registrator. Through steps S19 to S21, the same CPU functions as a first outputter. In step S18, the same CPU functions as a notifier. In step S25, the same CPU functions as a second outputter.

Hereinafter, processing of registration and output of read-in results according to the processing of FIG. 3 will be described in more detail by using a specific example.

First, FIG. 4 illustrates an example of the read-in result table.

The read-in result table illustrated in FIG. 4 is a table for registering three IDs for identifying an item of read-in result and a read-in result of the item indicated by the IDs, and is provided in the RAM 123. Data format of this table is set by firmware of the read-in device 100, and a table of constant format is used irrespective of algorithm of the input processing Sᵢₙ and the output processing Sₒᵤₜ.

In this manner, it is not necessary to define a data format in the description of the input format and the output format for setting the algorithm of the input processing Sᵢₙ and the output processing of Sₒᵤₜ. Therefore, when a user having little knowledge creates the input format and the output format, the formats can be created relatively easily.

Further, it is also possible to prevent size of the read-in result table from becoming excessively large due to a defect in setting or the like. When there is a large constraint of memory capacity in the read-in device 100, the number of registerable read-in results and/or the maximum capacity of storable read-in results may be set in advance.

All of the three types of IDs registered in the read-in result table are identification information for identifying an item of read-in result, and the IDs are input format ID, parentheses ID and extraction ID in the example of FIG. 4.

Among them, the input format ID is an ID of an input format which the decoding result satisfies in step S14.

The parentheses ID is, although details will be described later in a second example and a third example, an ID of parentheses which instruct extraction of characters in the input format. In the read-in device 100, plural extraction instructions can be included in one input format, and the parentheses ID is an ID for distinguishing according to what instruction each extracted character string is extracted. Note that the field of this parentheses ID can also be used for registering an application ID which will be described in the third example.

The extraction ID is, although details will be described later in the second example and the third example, an ID for distinguishing, when plural times of extractions are performed according to an extraction instruction related to the same parentheses of the same input format, what number of order each extracted character string is extracted according to this instruction.

In the description and diagrams below, unless mentioned otherwise, the IDs for identifying an item of read-in result are described as ‘[1,2,3]’ in the order of the input format ID, the parentheses ID, and the extraction ID.

In the field of read-in results, character strings extracted from the decoding result are registered without any change or, when a processing is instructed by the input format, registered after this processing is performed, according to the input format.

### FIRST EXAMPLE

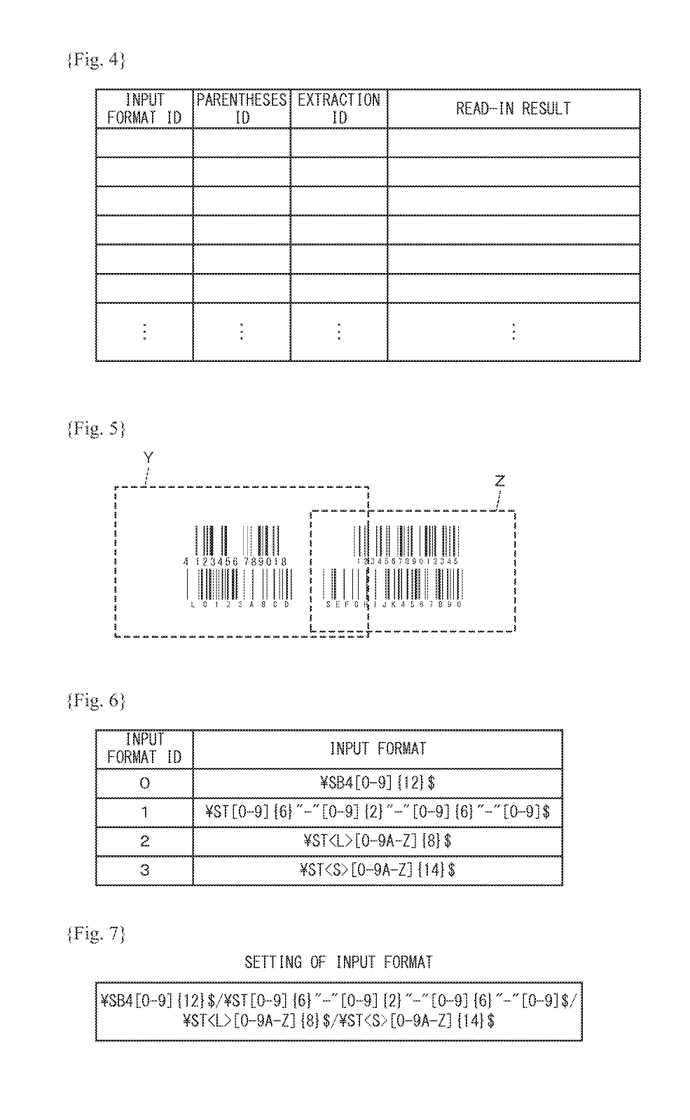

### FIG. 5 to FIG. 15

Next, the first example of registration and output of read-in results will be described.

This first example is an example of outputting information expressed by four barcode symbols as illustrated in FIG. 5. Note that the character string depicted under a code symbol indicates a character string which will be obtained by decoding the code symbol. The same applies in other drawings.

FIG. 6 illustrates input formats used for verification of decoding result and registration of read-in result in the first example.

In the read-in device 100, as illustrated in FIG. 6, the input format is described using a format in which some functions are added to a common regular expression. Further, plural input formats can be registered. In the example of FIG. 6, input formats corresponding respectively to the four barcode symbols described in FIG. 5 are prepared. The input format ID is an ID for distinguishing each of the input formats, and is also used as an ID for identifying an item of read-in result in the read-in result table illustrated in FIG. 4.

Then, in the input format with input format ID=0, ‘¥SB’ is a symbol indicating that the decoding result is in the form of JAN code. This symbol indicates the form of the decoding result, and does not indicate that a specific character is included in the decoding result. The next ‘4’ has no decoration and indicates an one-byte numeral ‘4’ itself. The next ‘[0-9]’ indicates any one-byte numeral, and ‘{12}’ indicates that the immediately previous character is repeated by the number of times written in { }. ‘$’ indicates the end of the character string.

Therefore, this input format describes a format such that only 12 characters of one-byte numerals are written after the one-byte numeral ‘4’ in JAN code. This is the format corresponding to the left top code symbol of FIG. 5.

In the input format of the next ID=1, ‘¥ST’ is a symbol indicating that the decoding result is in the form of Code128. This symbol also indicates the form of the decoding result, and does not indicate that a specific character is included in the decoding result. Further, ‘ “-” ’ indicates that a character written in “ ” should be added to the decoding result when a read-in result is registered in the read-in result table. Other symbols are the same as those described in the input format with ID=0.

Therefore, this input format indicates a format such that only six characters, two characters, six characters, and one character, 15 characters in total, of one-byte numerals are described in Code128. Further, the input format indicates that ‘-’ should be inserted after each of the sixth character, the eighth character and the fourteenth character when the read-in result is registered. This is the format corresponding to the right top code symbol of FIG. 5.

In the next input format with ID=2, ‘<L>’ indicates that a character written in < > is included in the decoding result, but this character should be deleted when the read-in result is registered in the read-in result table. Further, ‘[0-9A-Z]’ indicates any one-byte numeral or one-byte capital alphabet. The other symbols are the same as those described in the input format with ID=0.

Therefore, this input format indicates a format such that only eight characters of one-byte numerals or one-byte capital alphabets are described after ‘L’ in Code128 form. Further, the input format also indicates that the first ‘L’ should be deleted when the read-in result is registered. This is the format corresponding to the bottom left code symbol of FIG. 5.

The symbols used in the input format with ID=3 have the same meaning, and this input format indicates a format such that only 14 characters of one-byte numerals or one-byte capital alphabets are written after ‘S’ in Code128 form. Further, the input format also indicates that the first ‘S’ should be deleted when the read-in result is registered. This is the format corresponding to the bottom right code symbol of FIG. 5.

Note that in the above four input formats, parentheses instructing extraction of character have not appeared. However, it is assumed that it is instructed that any character not specified to be deleted will be registered in the read-in result table as a read-in result of an item with parentheses ID=0 and extraction ID=0 . The same applies when there are the parentheses instructing extraction of character. Specifically, also in this case, the part extracted according to the parentheses from the decoding result is registered as the read-in result of the item with parentheses ID corresponding to the parentheses, and simultaneously, any character not specified to be deleted in the entire decoding result is registered as a read-in result with parentheses ID=0 and extraction ID=0.

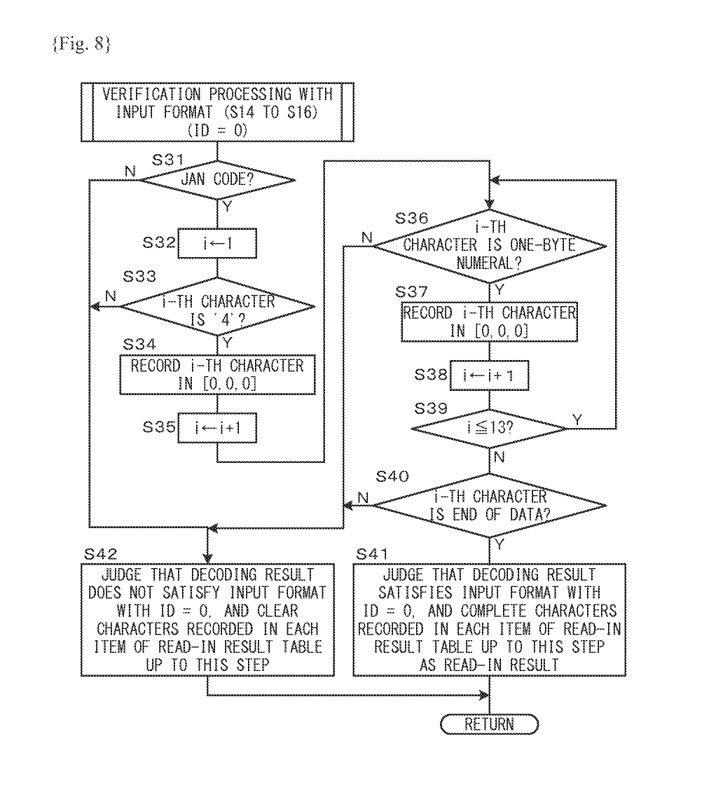

The input formats as above can also be described by arranging plural input formats delimited by ‘/’ as illustrated in FIG. 7. In this case, when any one of the arranged formats is satisfied, the decoding result is judged to be satisfying the input format.

However, for simplicity of description, in the read-in device 100, when such input formats delimited by ‘/’ are set, the input format ID is set for each one of the delimited input formats, so as to perform verification individually.

Further, the read-in device 100 has a function to set, when reading code symbols in which a character string of input formats as illustrated in FIG. 7 is coded in a state where a predetermined input setting mode is selected, input formats according to the character string. When input formats delimited by ‘/’ are set, the read-in device 100 automatically sets the input format ID for each of the input formats, and registers the input format IDs in the form illustrated in FIG. 6. Note that it is preferable that the order of setting the input format ID is determined in advance such as ascending order from the one described first. This is for allowing comprehension of the input format ID to be specified for selecting a desired item when output data are generated.

By the above function, the user operating the read-in device 100 can perform setting of input format just by reading a code symbol in which a character string of input format is coded by mostly the same operation as when the code symbols as read-in targets as illustrated in FIG. 5 are read.

Note that the read-in device 100 may be structured to allow this setting through data communication from the external device.

Next, a verification processing of decoded symbols and input formats will be described.

In the input processing Sᵢₙ of the processing illustrated in FIG. 3, the CPU of the control circuit 122 performs a verification processing of the decoding result and the input format for all the set input formats. When input formats as in FIG. 6 are set, the verification processing is performed sequentially for the input formats with ID=0 to ID=3.

Here, FIG. 8 illustrates an example of the verification processing performed for the input format with input format ID=0.

The algorithm of this processing is automatically generated by the CPU of the control circuit 122 through interpretation of a character string of an input format by executing predetermined firmware at an appropriate timing such as when the input format is set or when the processing of FIG. 3 is executed based on the input format. The same applies to the verification processing in examples below. Further, the processing of FIG. 8 is to perform extraction of a read-in result from a decoding result and registration in the read-in result table in parallel with the verification.

In the processing of FIG. 8, the CPU of the control circuit 122 first judges whether or not the decoding result satisfies the form of JAN code (S31).

When it is Yes here, the CPU sets value of a variable i at 1 (S32), and judges whether the i-th character (here the first character) of the decoding result is a one-byte numeral ‘4 ’ or not (S33). If it is Yes, the CPU judges that the decoding result satisfies the input format up to this point, and records the i-th character (here the first character) as a read-in result of the item with IDs [0,0,0] in the read-in result table (S34). Regarding the IDs of the item used here, the input format ID=0 is determined according to the ID of the input format used for verification, and the parentheses ID=0 and the extraction ID =0 are as described in the explanation of FIG. 6.

Note that when the item with [0,0,0] does not exist in the read-in result table, the CPU newly adds this item. Further, when a completed read-in result of the item with [0,0,0] is already registered, the CPU deletes this completed read-in result and newly preforms the recording. However, the read-in result deleted here may be saved in an appropriate memory so that it can be restored later.

Next, while incrementing the value of i (S35, S38), the CPU of the control circuit 122 repeats a processing (S36, S37) of, when the i-th character of the decoding result is a one-byte numeral, recording this character as a read-in result of the item with IDs [0,0,0] in the read-in result table while i is 2 to 13. Specifically, the CPU confirms that there are 12 one-byte numerals beyond ‘4’. The i functions as a pointer indicating the position of a character being processed.

Then, when the processing of the 13th character is finished, the value of i becomes 14 , and thus it is No in step S39, where the CPU judges whether the i-th character (fourteenth character) is the end of data or not (S40).

If it is Yes, it can be seen that the decoding result satisfies the input format with ID=0. Thus, the CPU completes the characters recorded in the items (only [0,0,0] here) of the read-in result table up to this step as a read-in result (S41), and the verification processing related to the input format with ID=0 is finished.

On the other hand, when it is No in any one of steps S31, S33, S36 and S40, it can be seen that the decoding result does not satisfy the input format with ID=0. Accordingly, the CPU clears the characters recorded in the items (only [0,0,0] here) of the read-in result table in the processing up to this step (processing of FIG. 8) (S42), and finishes the verification processing related to the input format with ID=0. Note that when addition of an item to the read-in result table has been performed in the processing up to this step, the CPU deletes the item itself. Further, when deletion of a completed read-in result has been performed, the CPU restores this read-in result.

Further, when proceeded to step S42, the CPU then proceeds to the verification processing related to an input format with ID=1. However, in this embodiment, it is assumed that the decoding result does not satisfy two or more input formats simultaneously, and when proceeded to step S41, the CPU does not perform the verification processing related to another input format. However, on the assumption that there may be cases where the decoding result satisfies two input formats simultaneously, it is also possible to employ a configuration to further perform the verification processing related to another input format even when the CPU proceeds to step S41.

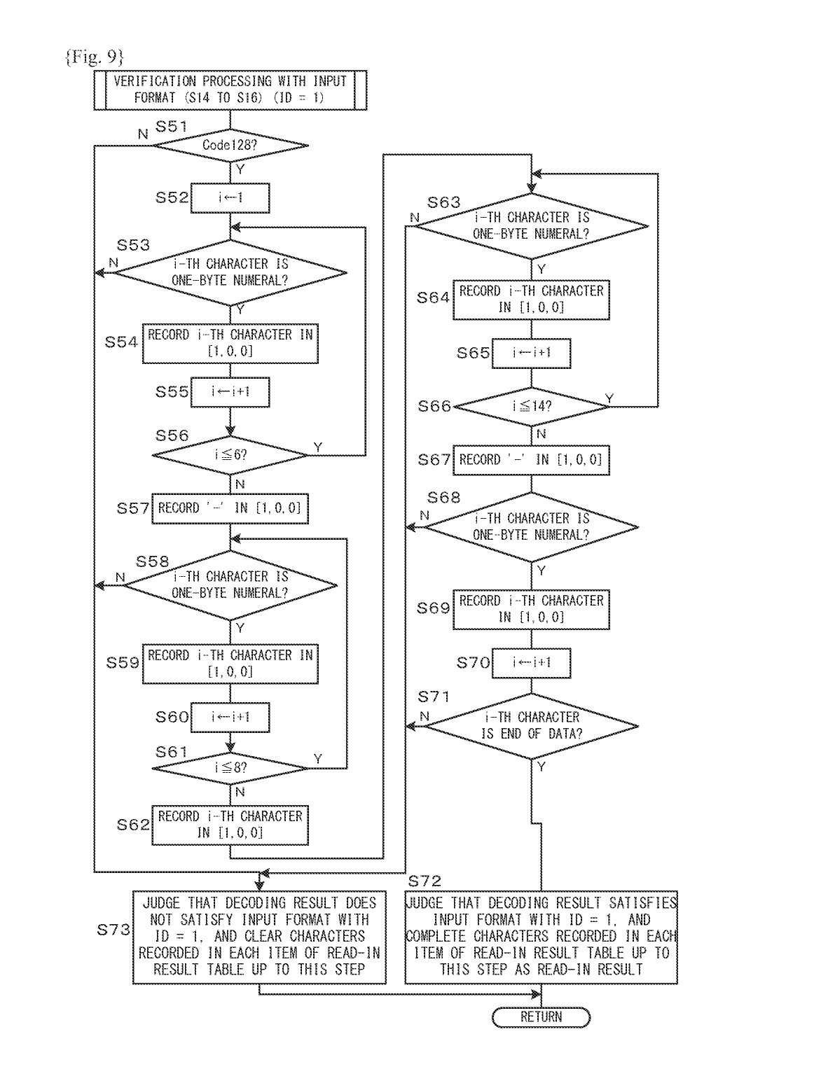

Next, FIG. 9 illustrates an example of the verification processing performed for the input format with input format ID=1.

In the processing of FIG. 9, the CPU of the control circuit 122 first judges whether or not the decoding result satisfies the format of Code128 (S51).

When it is Yes here, the CPU sets value of the variable i at 1 (S52), and while incrementing the value of i (S55), the CPU repeats a processing (S53, S54) of, when the i-th character of the decoding result is a one-byte numeral, recording this character as a read-in result of an item with IDs [1,0,0] in the read-in result table while i is 1 to 6. That is, the CPU confirms that the first six characters of the decoding result are one-byte numerals (S56). The IDs of items are the same as in the case of FIG. 8 except that the input format ID is 1.

Next, corresponding to the ‘ “-” ’ in the input format, the CPU records “-” as a read-in result of the item with IDs [1,0,0] in the read-in result table (S57).

Next, similarly to the case of steps S53 to S56, regarding i=7 and 8, the CPU performs a processing (S58 to S61) of, when the i-th character of the decoding result is a one-byte numeral, recording this character as a read-in result of the item with IDs [1,0,0] in the read-in result table. That is, the CPU confirms that the seventh and eighth characters of the decoding result are one-byte numerals.

Thereafter, the CPU of the control circuit 122 further performs recording of “-” similar to step S57 (S62), confirmation and recording from the ninth character to the fourteenth character (S63 to S66), recording of “-” (S67), and confirmation and recording of the fifteen character (S68 to S70).

Thereafter, when it is confirmed that the sixteenth character is the end of data (S71: i=16 at this point), it can be seen that the decoding result satisfies the input format with ID=1. Thus, the CPU completes the characters recorded in the items (only [1,0,0] here) of the read-in result table up to this step as a read-in result (S72), and finishes the verification processing related to the input format with ID=1.

On the other hand, when it is No in any one of steps S51, S53, S58, S63, S68 and S71, it can be seen that the decoding result does not satisfy the input format with ID=1. Accordingly, similarly to the case of step S42 of FIG. 8, the CPU clears the characters recorded in the items (only [1,0,0] here) of the read-in result table in the processing up to this step (processing of FIG. 9) (S73), and finishes the verification processing related to the input format with ID=1.

Thereafter, the CPU performs the verification processing for the input formats with ID=2 and 3 sequentially, but a description of details thereof is omitted.

In any case, when the input formats illustrated in FIG. 6 are set, as the processing of steps S14 to S16 of FIG. 3, the CPU of the control circuit 122 sequentially performs the verification processing related to the input formats with ID=0 to 3 with respect to the character string of the decoding result obtained in step S12. Then, as a result, information extracted based on the input format satisfied by the decoding result can be registered in the read-in result table as a read-in result of an item having ID identified based on the input format.

This registration is performed individually for each one of decoded code symbols, and thus a read-in result can be registered with respect to a code symbol which fits within the read-in area even when all the code symbols to be read cannot be fit within the read-in area at once as indicated by symbols Y and Z in FIG. 5.

For example, when the CPU of the control circuit 122 obtains an image of a read-in area denoted by the symbol Y in step S11 of FIG. 3, the decoding result of the upper code symbol satisfies the input format with ID=0, and the decoding result of the lower code symbol satisfies the input format with ID=2. Therefore, the read-in results of these code symbols can be registered in a state illustrated in FIG. 10 in the read-in result table.

Next, when an image of a read-in area denoted by the symbol Z is obtained, the decoding result of the upper code symbol satisfies the input format with ID=1, and the decoding result of the lower code symbol satisfies the input format with ID=3. Therefore, by adding the read-in results related to these code symbols to the state illustrated in FIG. 10, the read-in results can be registered in a state illustrated in FIG. 11.

Therefore, even when it is not possible to fit the code symbols to be read within the read-in area all at once, read-in results in plural read-in areas can be combined to collect the read-in results needed to be outputted.

Next, FIG. 12 illustrates an output format used for outputting a decoding result in the first example.

In the read-in device 100, in the output format, fixed character strings to be included in the output data, specifications of items of read-in results to be included in the output data, and special symbols can be described.

In the example illustrated in FIG. 12, a group of three IDs surrounded by [ ] is the specification of items of read-in results to be included in the output data. The IDs indicates that a character string registered in the read-in result table as a read-in result of an item indicated by the group of three IDs is disposed at the relevant position. For example, when the read-in result table is in the state illustrated in FIG. 11, a character string of ‘4123456789018’ is disposed at the position where [0,0,0] is described in the output format.

Further, the data which specify items of read-in results are also data which define what item of read-in result the read-in device 100 outputs, and which of the items is a necessary item. For example, when [0,0,0] is described in the output format, it can be seen that the read-in device 100 outputs a read-in result of an item with IDs [0,0,0], and that the item with [0,0,0] is a necessary item which has to be included in the output.

There can also be an item which has a possibility to be included in the output but is not necessary, and this point will be described in third and fourth examples.

Further, in the example illustrated in FIG. 12, ‘¥×0D’ is a special symbol indicating a line feed code.

The output format as above can be set by a method similar to the case of the input format.

Specifically, the read-in device 100 has a function to set, upon reading a code symbol in which the character string of the output format as illustrated in FIG. 12 is coded in a state that a predetermined output setting mode is selected, the output format according to this character string.

Although not illustrated here, similarly to the case of the input format, when setting of output formats delimited by ‘/’ is specified, the read-in device 100 automatically sets an output format ID for each of the output formats, and registers the output format IDs in a form similar to those in FIG. 6. However, only one output format can be used simultaneously, and when plural output formats are set, the read-in device 100 selects one of them as an output format to be used according to an instruction from the user.

By the above function, the user who operates the read-in device 100 can set the output format by just reading the code symbol, in which the character string of the output format is coded, by substantially the same operation as when reading the code symbol as the read-in target as illustrated in FIG. 5.

Note that this setting or selection of the output format to be used may also be performed by data transmission from the external device.

Further, it is possible to code, as one code symbol, a character string in which an input format and an output format are connected, and allow the read-in device 100 to read it so as to set the input format and the output format at once. In this case, it is conceivable that rules are defined in advance such that the first or the last one of the character strings delimited by ‘/’ is taken as the output format, or that, to each format, an identifier indicating whether the format is an input format or an output format is added, thereby enabling to distinguish them.

Next, an output processing using the above output format will be described.

In the output processing Sₒᵤₜ of the processing illustrated in FIG. 3, the CPU of the control circuit 122 performs the processing of steps S19 and S20 based on the set output format. The algorithm of the processing is automatically generated by the CPU of the control circuit 122 through interpretation of a character string of the output format by executing predetermined firmware at an appropriate timing such as when the output format is set or when the processing of FIG. 3 is executed based on the output format. The same applies to examples below.

Note that an example to be described below is an example where the processing of step S19 and the processing of step S20 are performed separately.

First, FIG. 13 illustrates a flowchart of registration judgment processing corresponding to step S19 when the output format illustrated in FIG. 12 is set.

In the processing of FIG. 13, with respect to each of the items with IDs [0,0,0], [1,0,0], [2,0,0], and [3,0,0] which are recognized to be necessary based on the output format, the CPU of the control circuit 122 judges whether or not a read-in result of the item is registered in the read-in result table (S81 to S84).

Then, when all of them are registered, the CPU judges that all data of the necessary items are registered in the read-in result table (S85) and finishes the processing. In this case, the judgment of step S19 of FIG. 3 results in Yes. On the other hand, when at least one of them is not registered, the CPU judges that data of the necessary items are not collected (S86) and finishes the processing. In this case, the judgment of step S19 of FIG. 3 results in No.

As can be seen from FIG. 3, only when the processing of FIG. 13 proceeds to step S85, the CPU proceeds to the processing corresponding to the next step S20.

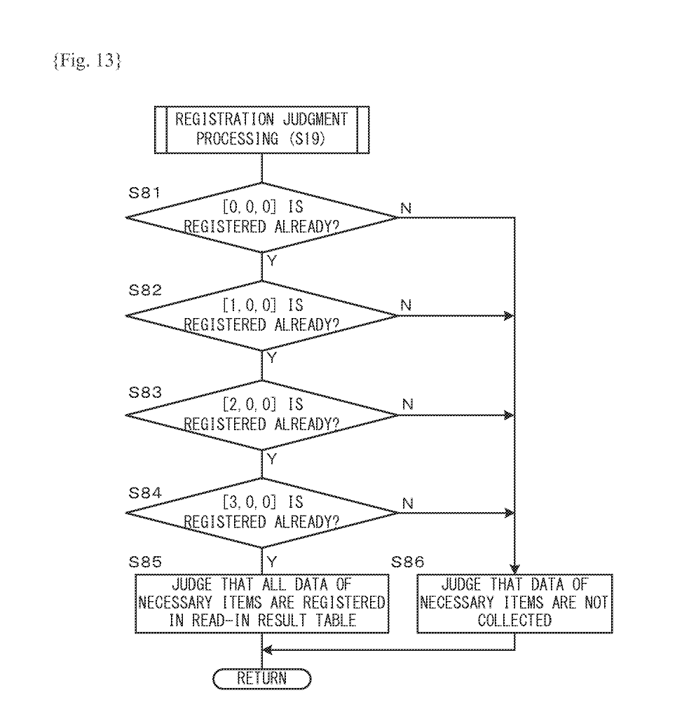

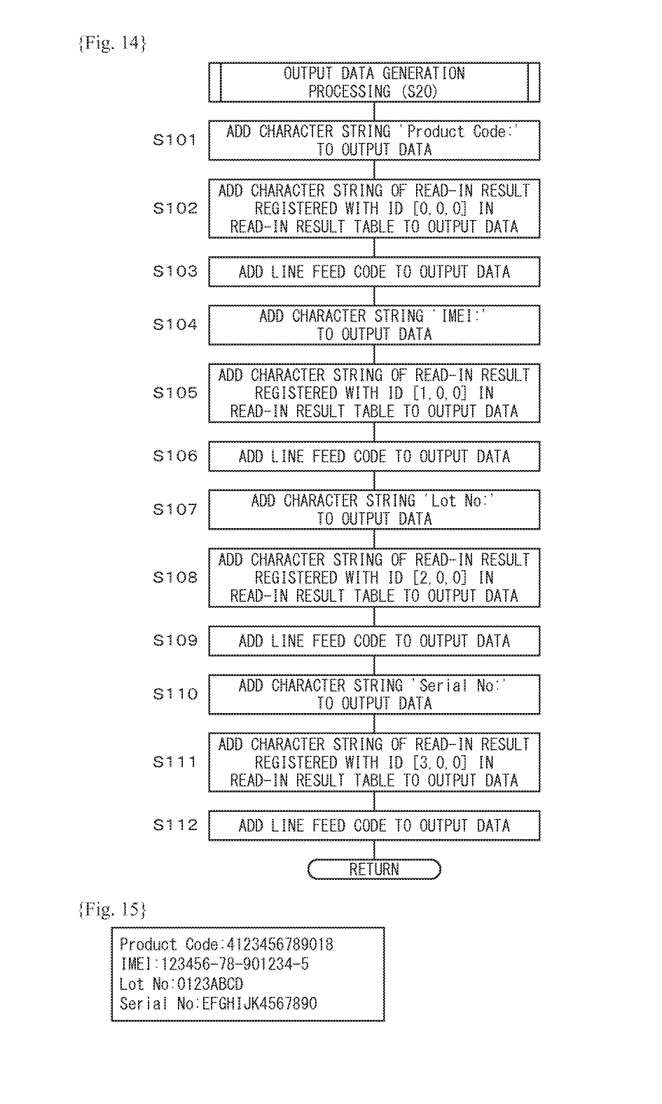

FIG. 14 illustrates a flowchart of output data generation processing corresponding to step S20 in the case where the output format illustrated in FIG. 12 is set. This processing starts from a state where the output data are blank.

In the processing of FIG. 14, the CPU of the control circuit 122 first adds to the output data a character string “Product Code:” at the head of the output format (S101). Next, corresponding to the specification of the read-in result described next to the character string added in step S101 in the output format, the CPU adds the character string of the read-in result of the item with IDs [0,0,0] registered in the read-in result table to the output data (S 102). Next, corresponding to the special symbol ‘¥×0D’ thereafter, the CPU adds the line feed code to the output data (S103).

Thereafter, in the order described in the output format, the CPU adds sequentially to the output data a character string ‘IMEI:’ (S104), the character string of the read-in result of the item with [1,0,0] (S105), the line feed code (S106), a character string ‘Lot No:’ (S107), the character string of the read-in result of the item with [2,0,0] (S108), the line feed code (S109), a character string ‘Serial No:’ (S110), the character string of the read-in result of the item with [3,0,0] (S111), and the line feed code (S112), and ends the processing.

The CPU of the control circuit 122 generating the algorithm of the above processing illustrated in FIG. 13 and FIG. 14 functions as an output item identifier.

Further, when the read-in result table is in the state illustrated in FIG. 11, the output data generated thus are as illustrated in FIG. 15. Specifically, even when code symbols coding data of items scheduled to be outputted cannot be fit within the read-in area at once, if necessary data could be read by dividing in plural times, the output data including read-in results of all the scheduled items can be generated by combining these read-in results.

The CPU of the control circuit 122 outputs the output data to the predetermined external device by the processing of step S21 of FIG. 3. This output may be performed by two-way communication using RS-232 C, USB (Universal Serial Bus), Bluetooth (registered trademark), or the like, or may be performed by one-way communication to just transmit information unilaterally to the external device from the read-in device 100 by using USB-HID (Human Interface Device), Keyboard Wedge, or the like.

### SECOND EXAMPLE

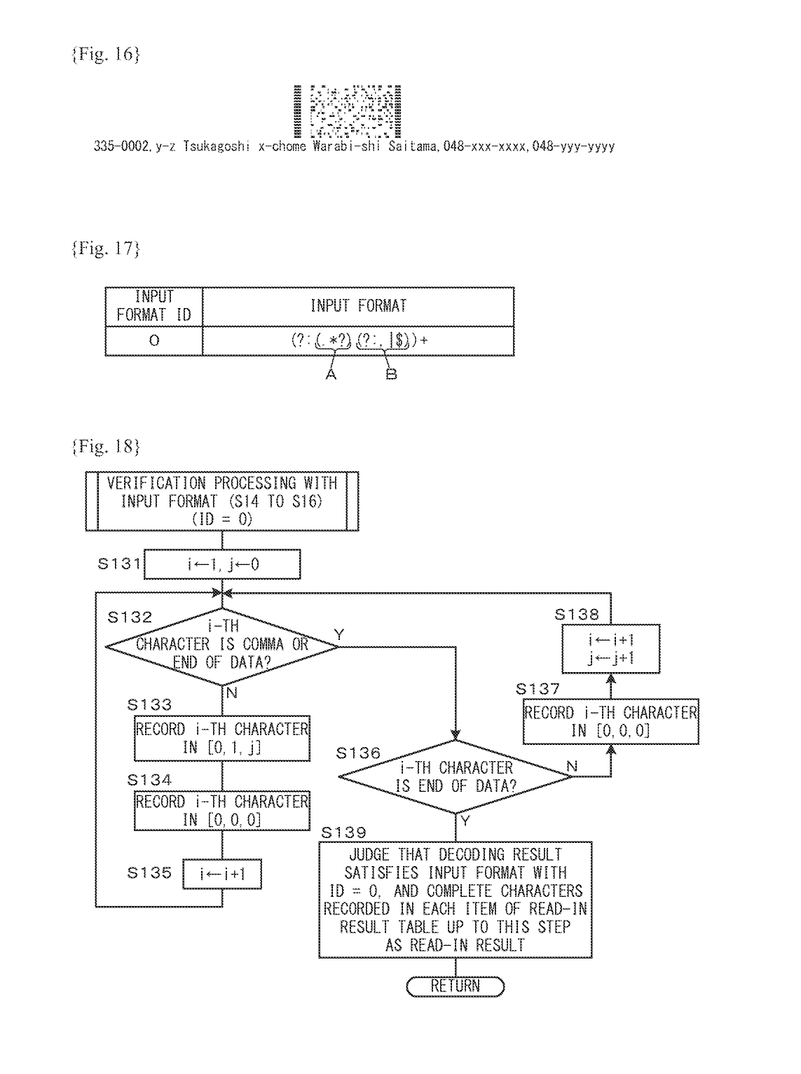

### FIG. 16 to FIG. 21

Next, a second example of registration and output of read-in results will be described.

This second example is an example of outputting information expressed by one two-dimensional barcode symbol as illustrated in FIG. 16. Further, it is an example of performing extraction of read-in results of plural items according to one input format.

Note that, in this example, although there is only one two-dimensional barcode symbol and only one input format is set corresponding to the barcode symbol for simplicity of description, it is of course possible to output information expressed by plural two-dimensional barcode symbols and to set plural input formats corresponding to the barcode symbols.

FIG. 17 illustrates an input format used for verification of decoding result and registration of read-in result in the second example.

In this input format, first, parentheses ‘( )’ are the parentheses instructing extraction of characters, which are described in FIG. 4. Specifically, it is an instruction to register the character string of a portion corresponding to the description in the parentheses as a read-in result of an item having the parentheses ID according to the order of appearance of parentheses. However, if there is ‘?:’ at the head of the character string in parentheses like ‘(?:)’, extraction and registration of the character string are not performed. Therefore, in the input format illustrated in FIG. 17, the parentheses actually instructing to extract characters is the portion indicated by a symbol A.

Note that in either case, character strings in parentheses are considered as a group of character strings when the following repetition or the like is considered.

Further, ‘.’ in parentheses indicated by the symbol A denotes an arbitrary character, ‘*’ denotes a repetition of zero or more times of the immediately previous character, and ‘?’ denotes a repetition of zero or one time of the immediately previous character. Moreover, ‘,’ in the parentheses indicated by a symbol B has no special meaning and denotes a character of comma, ‘|’ denotes that either of previous or succeeding character may be included (OR), and ‘$’ denotes an end of data. ‘+’ at the end denotes a repetition of one or more times of the immediately previous character.

From the above, in the input format illustrated in FIG. 17, the part indicated by the symbol B indicates the comma or the end of data, and the part indicated by the symbol A indicates a character string of an arbitrary number of characters (zero is possible) delimited by this comma or end of data. Then, ‘+’ at the end indicates that there is one or more groups of them.

That is, the input format illustrated in FIG. 17 indicates that the decoding result is an arbitrary number of (may also be one) character strings delimited by a comma (when there is no comma, the whole is recognized as one character string). Further, the parentheses of the part of the symbol A indicate that each character string thereof is extracted as a read-in result of an item with parentheses ID of 1. Moreover, the parentheses also indicate that the extraction ID is determined in ascending order for items of respective extracted character strings such that the character string extracted first time (character string at the head) according to the parentheses is of the extraction ID=0, the character string extracted next is of the extraction ID=1, and so on.

Next, a verification processing of decoded symbols and input formats will be described.

FIG. 18 illustrates an example of the verification processing corresponding to the input format illustrated in FIG. 17.

In the processing of FIG. 18, the CPU of the control circuit 122 first sets value of a variable i at 1, and value of a variable j at 0 (S131). The i functions as a pointer indicating the position of a character being processed.

Next, the CPU judges whether or not the i-th character of the decoding result is a comma or an end of data (S 132). If it is neither of them, the CPU records the i-th character as a read-in result of an item with IDs [0 1,j] in the read-in result table (S133). Regarding the ID of the item, the input format ID=0 is determined according to the ID of the input format used for verification, the parentheses ID=1 is determined according to the position of parentheses in the input format specifying extraction of the relevant character, and the extraction ID=j is determined according to the number of times of extraction.

Further, the CPU records the i-th character also as a read-in result of the item with IDs [0,0,0] in the read-in result table (S134). This is irrelevant to extraction according to parentheses, but is for registering the whole decoding result.

After the above, the CPU increments the value of i (S135) and returns to step S132 to repeat the processing.

Further, when it is Yes in step S132, if the i-th character is not the end of data (No in S136), that is, it is a comma, the CPU records the i-th character (namely a comma) as a read-in result of the item with IDs [0,0,0] in the read-in result table (S137). Then, the CPU increments the values of i and j (S138) and returns to step S132 to repeat the processing. In this case, the IDs of the item in which characters are recorded in step S133 vary, and thus the character string thereafter will be registered as a read-in result of an item different from the item of the character string up to this point.

Then, when the processing reaches the end of data and it is Yes in step S136, the CPU judges that the decoding result satisfies the input format with ID=0, completes the characters recorded in the items of the read-in result table up to this step as a read-in result (S139), and finishes the verification processing.

In the processing of FIG. 18, the character strings delimited by the comma included in the decoding result can be registered as read-in results of items different from each other. That is, according to one input format, information of plural items can be extracted and registered as read-in results of these items.

Note that in the case of the input format illustrated in FIG. 17, the decoding result satisfies the input format irrespective of what character string it is, and thus no processing is provided for the case where the input format is not satisfied.

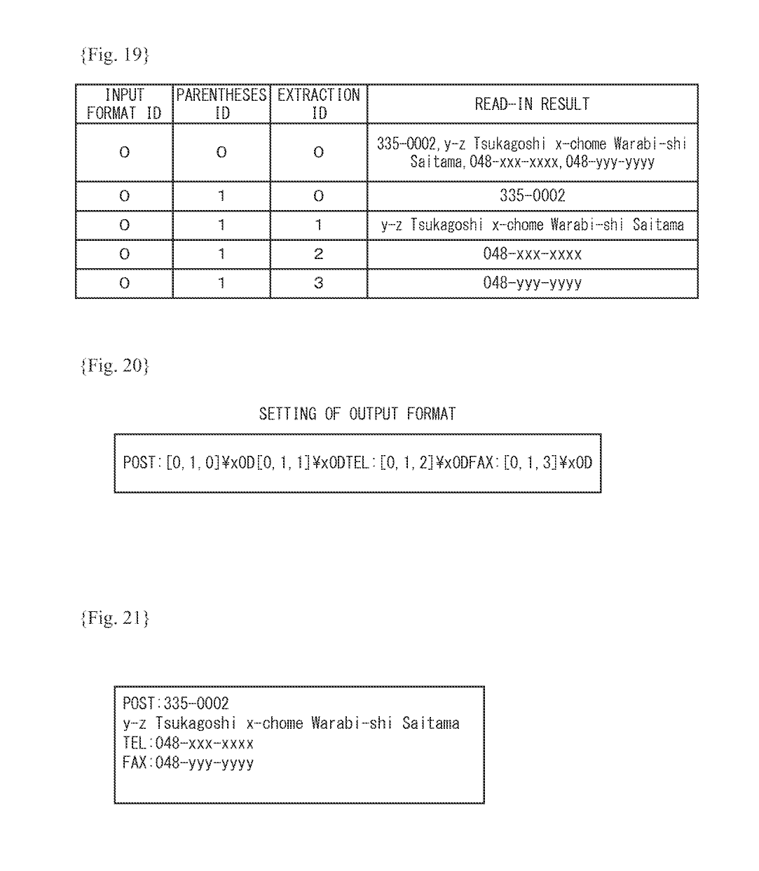

Further, when the code symbol illustrated in FIG. 16 is read and the verification processing illustrated in FIG. 18 is performed, the result of registration in the read-in result table is as illustrated in FIG. 19. The code symbol illustrated in FIG. 16 includes four character strings delimited by commas, and thus each of the strings is registered as a read-in result of an item with IDs [0,1,0-3]. Further, the decoding result itself is registered as a read-in result of the item with IDs [0,0,0]. Note that when exclusion by < > or insertion by “ ” is specified, registration to [0,0,0] is affected by the specification.

Next, FIG. 20 illustrates an output format used for outputting the decoding result in the second example.

Also regarding this output format, the description format is similar to that illustrated in FIG. 12. Then, the CPU of the control circuit 122 generates algorithm corresponding to the processing of steps S19 and S20 of FIG. 3 based on this output format.

Illustration of the processing using a flowchart is omitted, but an overview is given as follows.

First, in the registration judgment processing corresponding to step S19, items with [0,1,0], [0,1,1], [0,1,2], [0,1,3] are assumed as necessary items.

In the output data generation processing corresponding to step S20, the CPU generates output data in which a character string “POST:”, a character string of the read-in result of the item with [0,1,0], the line feed code, a character string of the read-in result of the item with [0,1,1], the line feed code, a character string ‘TEL:’, a character string of the read-in result of the item with [0,1,2], the line feed code, a character string ‘FAX:’, a character string of the read-in result of the item with [0,1,3], and the line feed code are included in this order.

Regarding the read-in result of the item with [0,0,0], the registration is performed but it is not used for generation of the output data.

When the read-in result table is in a state illustrated in FIG. 19, the output data generated according to the above are as illustrated in FIG. 21. The output method thereof is similar to that in the first example.

### THIRD EXAMPLE

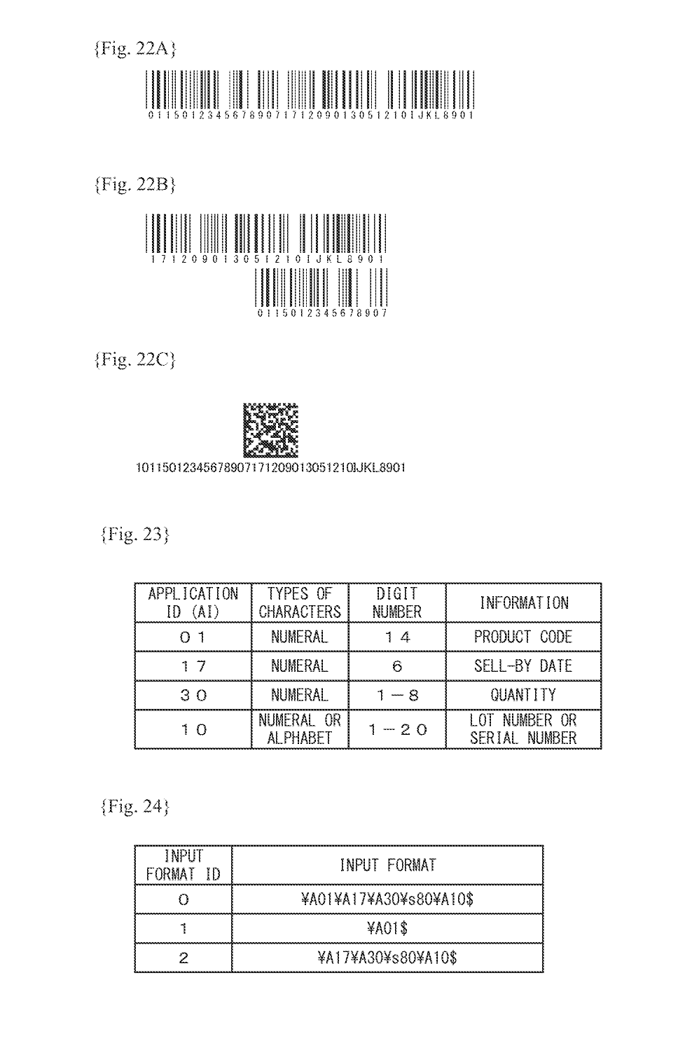

### FIG. 22A to FIG. 31

Next, a third example of registration and output of read-in results will be described.

This third example is an example of the case where the code symbol indicating information to be outputted is of a format which differs depending on the case as illustrated in FIG. 22A to FIG. 22C. It is also an example of using an application identifier (AI) instead of the parentheses ID for identifying an item of a read-in result.

The application identifier is an identifier used in a description format of product information defined by an organization called GS1. In this format, as illustrated in FIG. 23, an application identifier, types of characters used for describing the relevant information and a digit number are defined for respective items of information which are desired to be expressed by a code symbol.

If a table describing, as illustrated in FIG. 23, a description format of data for every application identifier is stored in the non-volatile memory 124 regarding the format used, the CPU of the control circuit 122 can comprehend what information is included in what description format in a character string obtained by decoding the code symbol based on this table and the application identifier included in the character string.

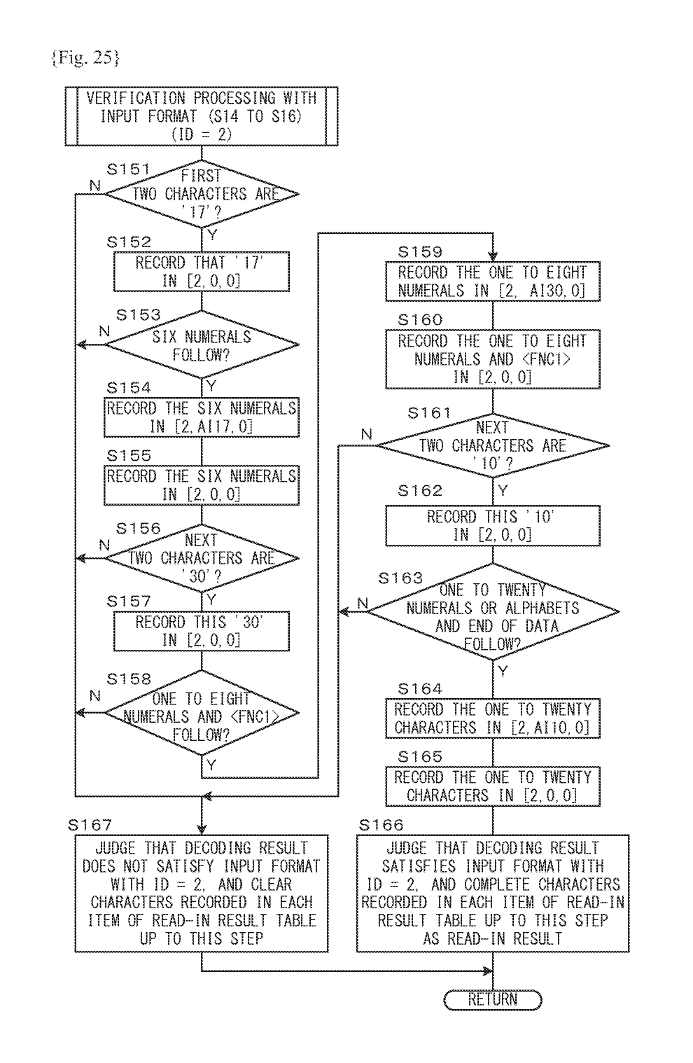

Here, FIG. 24 illustrates input formats used for verification of decoding result and registration of read-in result in the third example.

In this third example, these input formats are described using the above-described application identifier. Specifically, two one-byte numerals following ‘¥A’ indicate that data indicated by the application identifier are to be included in the decoding result. For example, ‘¥A01’ indicates data with the application identifier ‘01’.

Further, ‘¥s80’ indicates a special character ‘<FNC1>’ indicating an end of variable length data. This special character is not described below the code symbols illustrated in FIG. 22A to FIG. 22C.

It is the same as the cases of the first and second examples in that ‘$’ indicates the end of data.

Based on the above, the input format with ID=0 indicates that data with the application identifiers ‘01’, ‘17’, ‘30’, and ‘10’ line up in this order. Further, data with the application identifier ‘30’ is of variable length, and thus <FNC1> comes to the end thereof. Data with the application identifier ‘10’ is also of variable length, but since they are located at the end of the entire character string, the end of the variable data can be indicated by the data end, and <FNC1> is not used.

Further, when the application identifier is used for identifying data, the description of the application identifier also indicates that a character string of the data part corresponding to the relevant application identifier should be extracted, and the extracted character string should be registered as the read-in result in the read-in result table. Also in this case, as the IDs identifying an item, the application identifier is used as the parentheses ID, and the extraction ID is assumed as 0. The input format ID is according to the ID of the input format which is used for verification.

Note that the application identifier is used as the parentheses ID in this example, but regarding the application identifier, by adding “AI” to the head thereof, the same item of the ‘parentheses ID’ can be shared between the parentheses ID as in the first and second examples and the application identifier. One example is to describe ‘AI01’ when the application identifier is ‘01’.

Next, the input format with ID=b 1 indicates that only data with the application identifier ‘01’ is included.

The input format with ID=2 indicates that data with the application identifiers ‘17’, ‘30’, and ‘10’ line up in this order.

Incidentally, although details will be described in a description of the output format, the third example is an example of outputting data with the application identifiers of ‘01’, ‘17’, ‘30’ and ‘10’.

The input format with ID=0 is a format assuming that all of these data are described in one code symbol. However, as long as it is in a format decodable by the control circuit 122, the format of the code symbol is of no object. As long as the character string can be obtained as the decoding result, the character string can be verified similarly with the input format, either from the barcode as illustrated in FIG. 22A or the two-dimensional code as illustrated in FIG. 22C.

Further, the input formats with ID=1 and ID=2 are formats assuming that the data to be outputted are described in a dispersed manner in plural code symbols as illustrated in FIG. 22B. The input format with ID=1 corresponds to the lower code symbol, and the input format with ID=2 corresponds to the upper code symbol.

Also in this third example, the CPU of the control circuit 122 sequentially performs the verification processing for all the set input formats in the input processing Sᵢₙ.

Therefore, when the code symbol illustrated in FIG. 22A or FIG. 22C is read, the CPU judges that the input format with ID=0 is satisfied, and consequently, the read-in results of all the four necessary items are collected by one reading.

On the other hand, when the code symbol illustrated on the lower side of FIG. 22B is read, the CPU judges that the input format with ID=1 is satisfied, and registers only the read-in result of the item with the application identifier ‘01’. However, when the code symbol illustrated on the upper side of FIG. 22B is read thereafter, the CPU judges that the input format with ID=2 is satisfied, and registers the read-in results of the three remaining items, and consequently, the read-in results of the four necessary items are collected. Of course, when both the two code symbols illustrated in FIG. 22B fit within the read-in area in one reading, although verification with the decoding result is performed separately, the read-in results of all the four necessary items are collected by image data of one frame.

Then, irrespective of whether the read-in results are obtained from one code symbol or obtained from two code symbols, the same output can be performed.

Here, FIG. 25 describes the verification processing of decoded symbols and input formats in the third example. FIG. 25 illustrates the processing corresponding to the input format with ID=2 as a representative, and regarding the processing corresponding to the other input formats, illustration and detailed explanations are omitted.

Note that the CPU of the control circuit 122 refers also to the table illustrated in FIG. 23 when generating algorithm illustrated in FIG. 25.

In the processing of FIG. 25, the CPU of the control circuit 122 first judges whether the first two characters are ‘17’ or not (S151). This is a processing corresponding to the description indicating that there are data with the application identifier ‘17’ at the head.

Then, if it is Yes, the CPU records this ‘17’ in the read-in result table as a read-in result of an item with IDs [2,0,0] (S152). This is for registering the entire decoding result irrespective of extraction according to the application identifier.

Thereafter, the CPU of the control circuit 122 judges whether or not six numerals follow the first two characters in the decoding result (S153). This is a processing corresponding to that there is registered in the table of FIG. 23 that data with the application identifier ‘17’ are six numerals.

Then, if it is Yes, it can be seen that data with the application identifier ‘17’ are included correctly, and thus the CPU records these six numerals in the read-in result table as a read-in result of an item with IDs [2,AI17,0] (S154). Further, the CPU records the numerals also as a read-in result of an item with IDs [2,0,0] (S155). Note that the second ID ‘AI17’ used in step S154 is the ID in which, to 17 as an application identifier, ‘AI’ is added as a symbol indicating that the character string is the application identifier. In this manner, it is possible to easily identify whether the ID registered in an item of parentheses ID is the parentheses ID itself or the application identifier.

Thereafter, similarly, the CPU executes the processing (S156 to S160) related to data with the application identifier ‘30’ and the processing (S161 to S165) related to data with the application identifier ‘10’. Note that <FNC1> is not recorded in step S159.

Then, once the processing finishes up to step S165, the CPU judges that the decoding result satisfies the input format with ID=2, complete the characters recorded in the items of the read-in result table in the processing up to this step as a read-in result (S166), and ends the processing.

On the other hand, when it is No in one of steps S151, S153, S156, S158, S161 and S163, it can be seen that the decoding result does not satisfy the input format with ID=2. Then, similarly to the case of step S42 of FIG. 8, the CPU clears the characters recorded in the items of the read-in result table in the processing up to this step (processing of FIG. 25) (S167), and ends the processing.

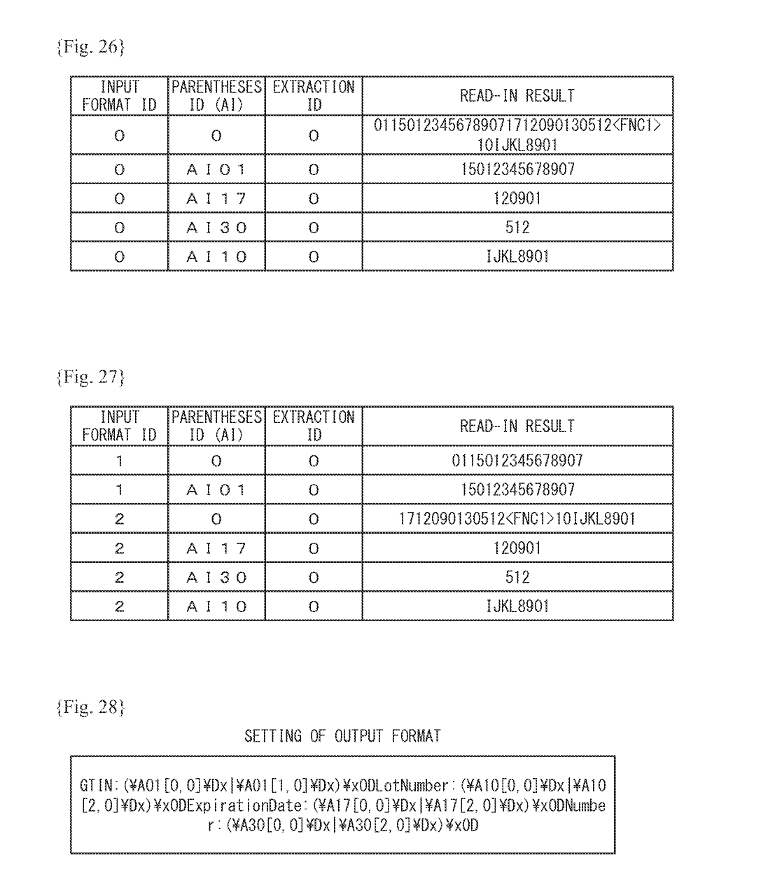

When the verification processing as above is applied together with those corresponding to the other input formats, the results of registration in the read-in result table when the code symbols illustrated in FIG. 22A and FIG. 22C are read are as illustrated in FIG. 26. Further, the results of the registration when the two code symbols illustrated in FIG. 22B are read are as illustrated in FIG. 27.

In these registration results, the read-in results corresponding to the respective application identifiers differ in input format ID according to the input format applied, but are common for the other IDs. Further, in FIG. 27, registration of the entire decoding result is performed for every code symbol. However, the data of this registration will not be included in the output data, and accordingly there is no particular meaning in the difference in this point.

Next, FIG. 28 illustrates an output format used for outputting the decoding result in the third example.

Also regarding this output format, the description format is basically similar to that illustrated in FIG. 12. However, in specification of read-in results to be included in the output data, the application identifier (parentheses ID) among the group of three IDs is placed outside [ ] and is denoted by ‘¥A’ and following numerals. In [ ] behind that, the input format ID and the extraction ID are described. Therefore, for example, ¥A01[0,0] has the same meaning as a specification of [0,AI01,0]. Further, ‘¥Dx’ means that data of an item specified immediately previously by using the application identifier are outputted. Further, the symbol OR described above in the description of FIG. 17 is also used for describing the output format.

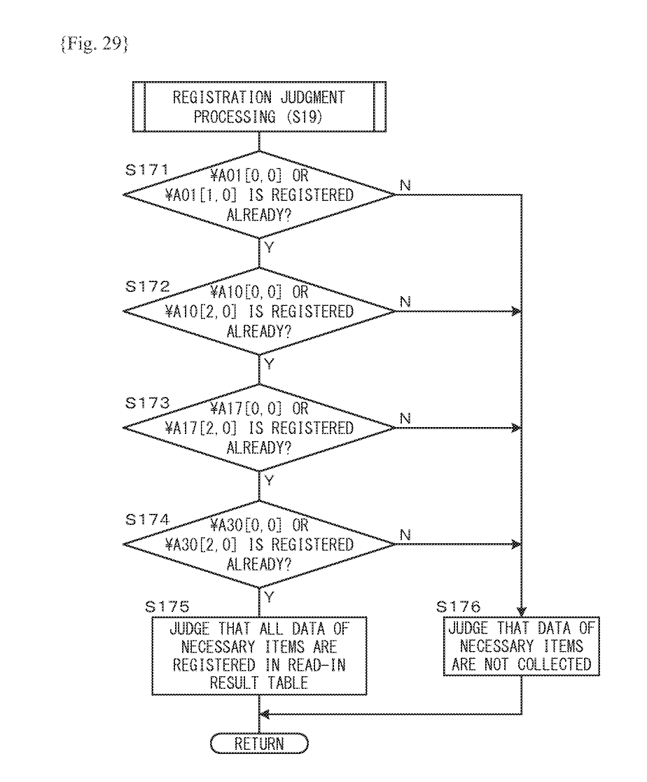

Next, FIG. 29 illustrates a flowchart of registration judgment processing corresponding to the output format illustrated in FIG. 28.

In the processing of FIG. 29, the CPU of the control circuit 122 first judges whether or not a read-in result of an item of ¥A01[0,0] or ¥A01[1,0] is registered in the read-in result table (S171). These are items listed in the first parentheses in the output format with the symbol specifying OR interposed therebetween. When either of the items is registered, the output data in the first parentheses can be generated, and thus the CPU proceeds to the next.

In the next step, the CPU judges whether a read-in result of the item of ¥A10[0,0] or ¥A10[2,0] is registered in the read-in result table or not (S 172). This corresponds to the description in the second parentheses in the output format.

When it is Yes, similarly corresponding to the descriptions in the third and fourth parentheses, the CPU judges whether read-in results of items ¥A17[0,0] or ¥A17[2,0], and ¥A30[0,0] or ¥A30[2,0] are registered in the read-in result table or not (S173, S174).

Then, when both of them are Yes, the CPU judges that all data of the necessary items are registered in the read-in result table (S175), and ends the processing. In this case, the judgment of step S19 of FIG. 3 results in Yes. On the other hand, when at least one of them is No, the CPU judges that the data of necessary items are not collected (S176), and ends the processing. In this case, the judgment of step S19 of FIG. 3 results in No.

Note that regarding the necessary items, in the processing of FIG. 29, it is considered to be necessary that a read-in result with respect to either of the items coupled by OR is registered. Alternatively, it can also be considered that the item corresponding to a specific application identifier is necessary.

Next, FIG. 30 illustrates a flowchart of output data generation processing corresponding to the output format illustrated in FIG. 28. This processing starts from a state that the output data are blank.

In the processing of FIG. 30, the CPU of the control circuit 122 first adds a character string ‘GTIN:’ at the head of the output format to the output data (S201).

Next, the CPU judges whether a read-in result of the item with ¥A01[0,0] is registered in the read-in result table or not (S202). Then, when it is registered, the CPU adds the character string of the read-in result of the item with ¥A01[0,0] to the output data (S203). When it is not registered, the CPU adds the character string of the read-in result of the item with ¥A01[1,0] to the output data (S204). These are processing corresponding to the description in the first parentheses in the output format. For plural formats coupled by OR, when output data can be generated according to the format described first, this format is employed or otherwise the next format is tried.

Next, the CPU adds the line feed code to the output data corresponding to the special symbol ‘¥×0D’ next (S205).

Thereafter, in the order described in the output format, the CPU adds a character string of ‘lot number:’ (S206), and when the read-in result of the item with ¥A10[0,0] is registered, adds this read-in result, or when it is not registered, adds the read-in result of the item with ¥A10[2,0] (S207 to S209). The CPU further adds the line feed code (S210).

The processing thereafter is omitted from the illustration, in which the CPU adds: a character string of ‘expiration data:’; the read-in result of the item with ¥A17[0,0] if it is registered or the read-in result of the item with ¥A17[2,0] if not registered, the line feed code; a character string ‘quantity:’; the read-in result of the item with ¥A30[0,0] if it is registered or the read-in result of the item with ¥A30[2,0] if not registered; and the line feed code, to the output data in this order, and ends the processing.

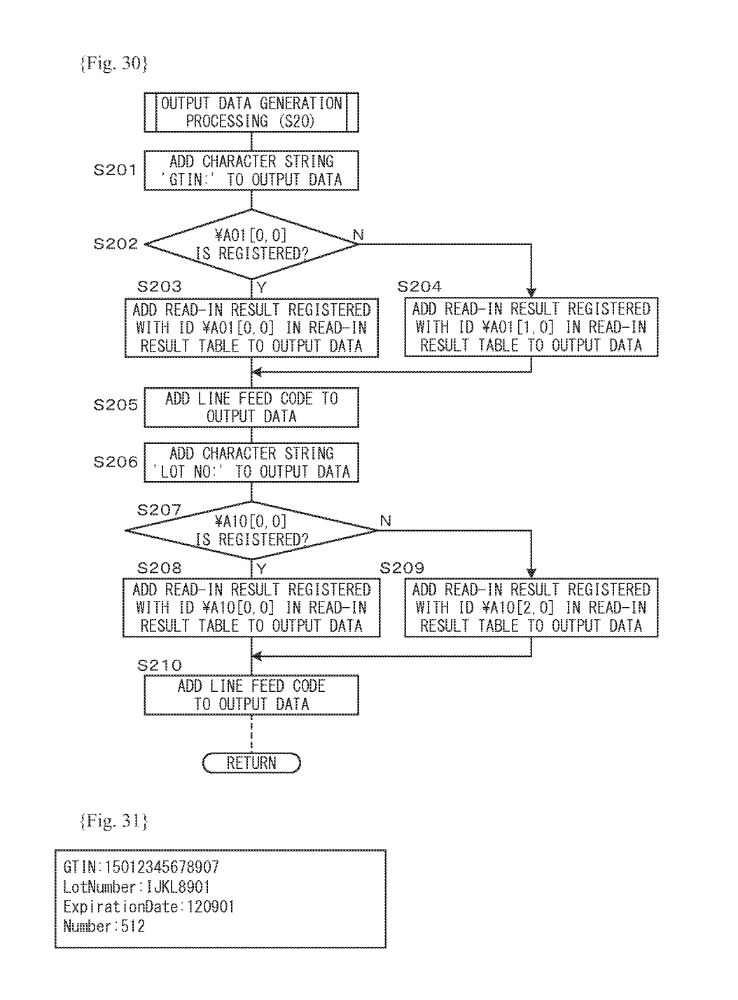

When the read-in result table is in a state illustrated in FIG. 26 or FIG. 27, the output data generated as above are as illustrated in FIG. 31. The generated output data are the same when the state of the read-in result table is in either case.

In other words, the same output can be performed irrespective of whether the read-in results are obtained from one code symbol or obtained from two code symbols.

Note that the application identifier used in this example need not be an identifier which is widely recognized in the public as long as the data of the table illustrated in FIG. 23 could be shared between the side where code symbols as read-in targets are created and the side where the read-in device 100 to be used for reading is set. That is, it is conceivable to use an original identifier created by the user.

### FOURTH EXAMPLE

### FIG. 32 to FIG. 37

Next, a fourth example of registration and output of read-in results will be described.

This fourth example is an example in which code symbols indicating information to be outputted are the same as those in the case of the third example, but input formats to be used are different. Accordingly, descriptions of portions common with the third example are omitted or simplified.

FIG. 32 illustrates an input format used for verification of decoding result and registration of read-in result in the fourth example.

The meanings of symbols used in this input format are basically the same as those which have been used in the previous examples, but ‘¥Ax’ denotes data corresponding to an arbitrary application identifier. Therefore, this input format indicates that one or more data corresponding to an arbitrary application identifier line up in the decoding result, and there may be up to one <FNC1> after each data.

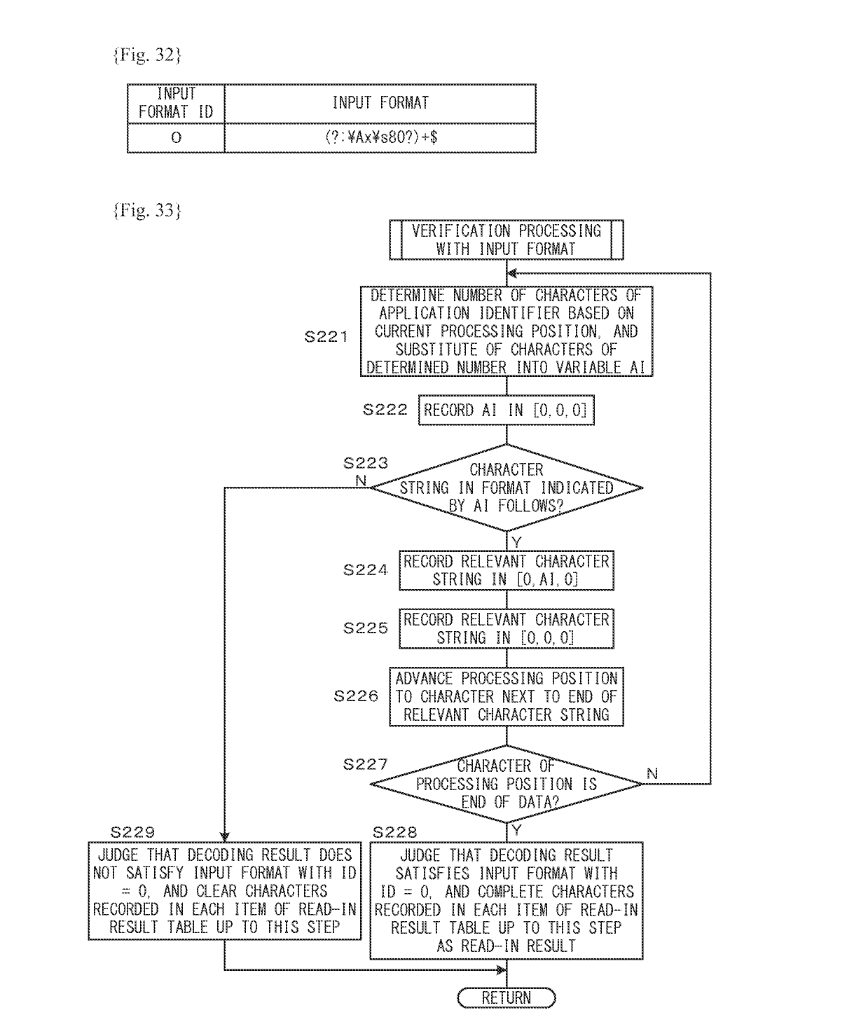

FIG. 33 describes verification processing of decoded symbols and the input format in the fourth example. At a point of starting this processing, it is assumed that the processing position is the first character of a decoding result.

In the processing of FIG. 33, the CPU of the control circuit 122 first determines the number of characters of the application identifier based on the current processing position, and substitutes the characters of the determined number into a variable AI (S221). The number of the characters of the application identifier is not limited to two which has been exemplified up to here, but by reading characters one by one from the head, it is possible to identify what number of characters the ID has. Thereafter, the CPU records the value of AI in the read-in result table as a read-in result of the item with IDs [0,0,0] (S222). This is to register the entire decoding result irrespective of extraction by the application identifier.

Thereafter, the CPU of the control circuit 122 judges whether or not the character string in the format indicated by AI substituted in step S221 follows the AI (S223). For example, when ‘01’ is substituted in step S221, the CPU judges whether or not data with the application identifier ‘01’, that is, a 14-digit numeral follows the ‘01’.

When it is Yes here, the CPU records the relevant character string in the read-in result table as a read-in result of an item with [0,AI,0] (S224). Note that although the second ID is simply described as ‘AI’ in the Figure, in order to indicate that it is the application identifier, an ID in which the character string ‘AI’ is added to the head of the value of the variable AI is used. In this step S224, the special character such as <FNC1> may be excluded from the record. Further, the CPU records the relevant character string also as a read-in result of the item with IDs [0,0,0] (S225).

Then, the CPU advances the processing position to the character next to the end of the relevant character string (S226), and judges whether the character of the processing position is the end of data or not (S227). When it is No here, the CPU returns to step S221 to repeat the processing, but when it is Yes, the CPU judges that the decoding result satisfies the input format with ID=0, completes the characters recorded in the items up to this step as a read-in result (S228), and ends the processing.

On the other hand, when it is No in step S223, it can be seen that the decoding result does not satisfy the input format with ID=0. Accordingly, similarly to the case of step S42 of FIG. 8, the CPU clears the characters recorded in the items of the read-in result table in the processing up to this step (processing of FIG. 33) (S229), and ends the processing.

Note that in step S223, No is judged also when the value of AI is not an appropriate value as the application identifier.

Also by using the above-described input format and verification processing, the registration result illustrated in FIG. 26 can be obtained when code symbols including data of four items as in FIG. 22A and FIG. 22C are read.

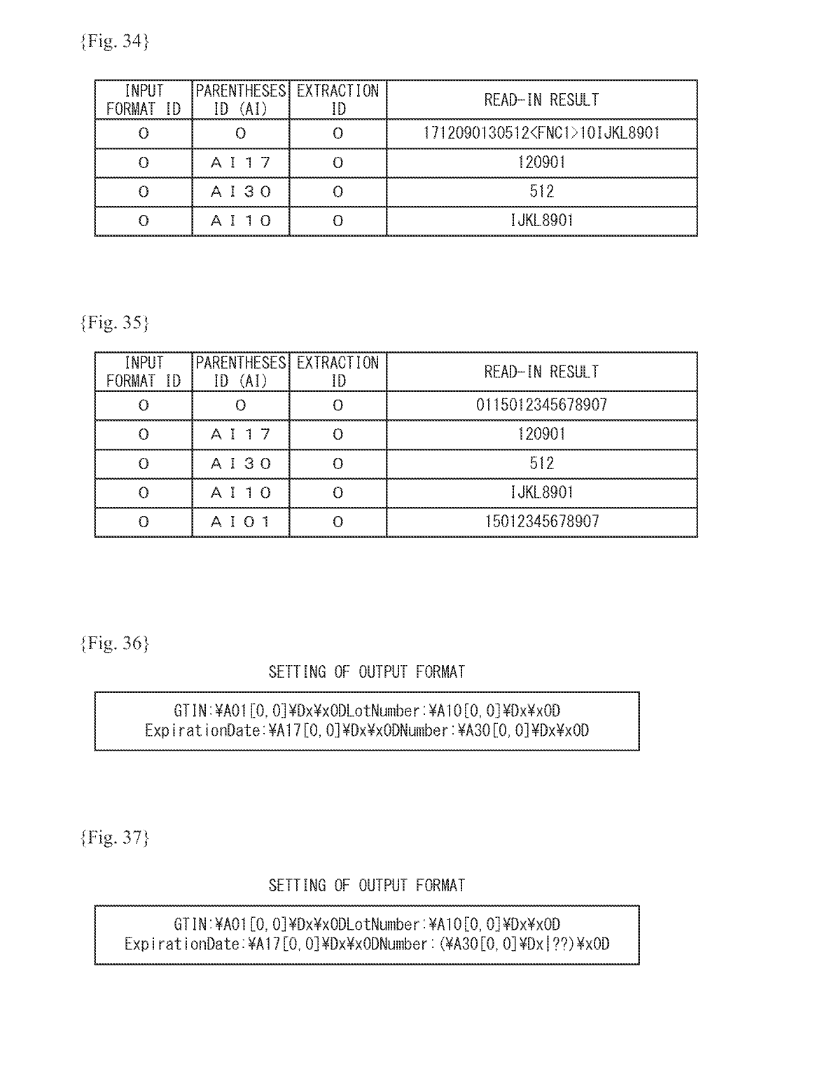

Further, when the data are described in two separate code symbols as in FIG. 22B, if the upper code symbol is read first, the registration result illustrated in FIG. 34 is obtained. When the lower code symbol is further read in this state, the registration result illustrated in FIG. 35 is obtained. In this state, the data registered in the item [0,0,0] are such that information of the lower code symbol which is read secondly is overwritten on the information registered in FIG. 34. Further, information with the application identifier ‘01’ described in the lower code symbol is additionally registered from the state of FIG. 34.

Consequently, when the two code symbols of FIG. 22B are read, the same character strings as those described in FIG. 26 are registered as the read-in results corresponding to the application identifiers. The IDs indicating the items are exactly the same as those illustrated in FIG. 26.

Accordingly, in the example of FIG. 4, the output format can be described as in FIG. 36. That is, either when the code symbol of FIG. 22A or FIG. 22C is read or when the code symbols of FIG. 22B are read, since the read-in result is extracted based on the same input format in either case, a description using OR as in the case of the third example is not necessary when output data are described.

Although a detailed description of the processing is omitted, when the data of the read-in result table are in a state illustrated in FIG. 26 or FIG. 35, if output data are generated based on the output format of FIG. 36, the same output data as those illustrated in FIG. 31 are completed.

Thus, by contriving the description of the input formats and the output formats, the same data can be obtained by shorter formats from the same code symbol.

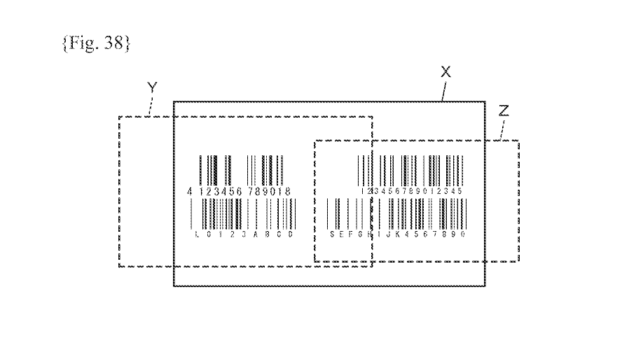

Note that in the example of FIG. 36, all the items with the application identifiers ‘01’, ‘10’, ‘17’ and ‘30’ are necessary items for output. However, when the item with ‘30’ for example is not a necessary item, as illustrated in FIG. 37, this can be expressed using the OR symbol.

In the last parentheses in the output format illustrated in FIG. 37, ‘??’ simply indicates that two question marks are outputted. Therefore, when the output format illustrated in FIG. 37 is used, if the read-in result of the item with the application identifier ‘30 ’ is not present, output data including ‘??’ instead are generated consequently, and hence it can be expressed that this is not a necessary item.

The description of the embodiment is thus concluded, but the structure of the device, the specific processing steps, the formats and the description method of data, and the like are of course not limited to those explained in the above-described embodiment.

For example, in the above-described embodiment, the combination of three IDs is used as IDs for identifying an item in the read-in result table, but a dedicated ID corresponding directly to an item may also be used.

Further, in the above-described embodiment, the read-in device is structured as a device reading code symbols, but it can be structured also as a device reading characters by OCR (Optical Character Recognition).

Further, it is not necessary that the output destination of the output data (read-in result) is a device having a separate casing. For example, it is conceivable that the read-in device is structured as a read-in module having an optical head portion and a small chip for data processing and is mounted on a substrate of a portable computer or a mobile phone device, and the output data are outputted to a main control portion of the portable computer or mobile phone device, or the like. In this case, the main control portion can be considered as the output destination device.

Further, the description rules of the input formats and the output formats are not limited to those in the above-described embodiment.

Moreover, the invention is applicable to an arbitrary device irrespective of portable type, stationary type, type incorporated in a kind of device, or the like as long as it is a device reading information in a read-in area.

Further, a program of this invention can be structured as a program for causing a computer to control a read-in device to realize the functions explained in the above-described embodiment. Such a program, besides storing in a memory of the computer in advance, can be provided by recording in a CD-ROM or a flexible disk as a recording medium, a non-volatile recording medium (memory) such as SRAM, EEPROM, or a memory card, or by making the program downloadable via a network. The above-described respective functions can be realized by installing this program and executing it by a CPU, or enabling the CPU to obtain this program from a memory or a download server and execute it.

Further, the structures and modification examples as have been described above can be applied by appropriately combining while they do not contradict with each other.

### INDUSTRIAL APPLICABILITY

As is clear from the above description, by a read-in device, a read-in result output method and a program of the invention, in the case where information in a read-in area is read as input information and read-in results thereof are outputted, read-in results of plural items can be outputted easily even when the read-in area is relatively small and it is difficult to fit therein all the information desired to be read at once.

Therefore, by applying this invention, operability or operating efficiency of the read-in device can be improved.

### REFERENCE SIGNS LIST

100 . . . read-in device, 110 . . . optical head portion, 111 . . . lens portion, 112 . . . CMOS, 113 . . . LED, 120 . . . decoder portion, 121 . . . first I/O, 122 . . . control circuit, 123 . . . RAM, 124 . . . non-volatile memory, 125 . . . second I/O

What is claimed is:

1.-17. (canceled)

18. A read-in device, comprising:
a reader configured to read information in a read-in area as input information;
an input setter configured to set input formats of information;
a registrator configured to register information of one or more items extracted from input information which matches one of the input formats set by the input setter among the input information read by the reader, based on the one input format, as a read-in result of the one or more items in a predetermined memory, the registrator registering information of an item for which any read-in result is not registered in the memory, among the extracted information, additively to a read-in result which has been already registered; and
a controller configured to perform control to repeat the reading by the reader and the registering by the registrator until the read-in result is registered for all necessary items;
a first outputter configured to read, when read-in results for all the necessary items are registered in the memory, the registered read-in results from the memory and output the read read-in results to a predetermined output destination device.

19. The read-in device according to claim 18, comprising:
an output setter configured to set an output format of the read-in results by the first outputter; and
an output item identifier configured to identify, based on the output format set by the output setter, what items of the registered read-in result the first outputter outputs and which of the items is a necessary item;
wherein the first outputter is configured to output read-in results of the items identified by the output item identifier among the read-in results registered in the memory, as information of a format according to the output format set by the output setter.

20. The read-in device according to claim 19, wherein the registrator is configured to register the information extracted from the input information with identification information specified based on the input format item-by-item.

21. The read-in device according to claim 18, wherein:
the input information is decoding results of an arbitrary number of code symbols in the read-in area;
the read-in device further comprises a first algorithm generator configured to generate a first algorithm for extracting one or more items of information from decoding result of one code symbol based on the input format set by the input setter; and
the registrator is configured to extract the one or more items of information from the input information by commonly applying the first algorithm to the decoding result of each of the code symbols included in the input information.

22. The read-in device according to claim 19, further comprising:
a second algorithm generator configured to generate a second algorithm for generating, based on the output format set by the output setter, information complying with the output format from the read-in results of items identified by the output item identifier;
wherein the first outputter is configured to generate the information to be outputted to the predetermined output destination device according to the second algorithm.

23. The read-in device according to claim 22, comprising:
a securer configured to secure a predetermined storage area in the memory for storing identification information of an item and the read-in result of the item corresponded with each other as a registration destination of the read-in result by the registrator, irrespective of settings of the input format and the output format;
wherein the output item identifier identifies the items for which the first outputter outputs the registered read-in result and the necessary item by the identification information of the items included in the output format; and
wherein the first outputter is configured to read, for the outputting, the read-in result of the item indicated by the identification information identified by the output item identifier from the predetermined storage area.

24. The read-in device according to claim 18, comprising:
a notifier configured to perform, every time the registrator newly registers a read-in result regarding an item for which a read-in result is not registered in the memory yet, a notification of the registration.

25. The read-in device according to claim 18, comprising:
a second outputter configured to output, when the input information read by the reader does not match any of the input formats set by the input setter, the input information to the predetermined output destination device.

26. A read-in result output method wherein a processor or hardware controlled by a processor executes:
reading information in a read-in area as input information;
setting input formats of information;
registering information of one or more items extracted from input information which matches one of the set input formats among the input information read in the reading, based on the one input format, as a read-in result of the one or more items in a predetermined memory, information of an item for which any read-in result is not registered in the memory, among the extracted information, being registered additively to a read-in result which has been already registered;
repeating the reading and the registering until the read-in result is registered for all necessary items;
reading, when read-in results for all necessary items are registered in the memory, the registered read-in results from the memory; and
outputting the read read-in results to a predetermined output destination device.

27. The read-in result output method according to claim 26 wherein the processor or the hardware further executes:
setting an output format of the read-in results in the outputting; and
identifying, based on the set output format, what items of registration are to be outputted in the outputting and which of the items is a necessary item;
wherein the outputting is outputting read-in results of the items identified in the identifying among the read-in results registered in the memory, as information of a format according to the set output format.

28. The read-in result output method according to claim 27, wherein the registering is registering the information extracted from the input information with identification information specified based on the input format item-by-item.

29. The read-in result output method according to claim 26, wherein:
the input information is decoding results of an arbitrary number of code symbols in the read-in area;
the processor or the hardware further executes generating a first algorithm for extracting one or more items of information from decoding result of one code symbol based on the input format set by the input setter; and
in the registering, the one or more items of information is extracted from the input information by commonly applying the first algorithm to the decoding result of each of the code symbols included in the input information.

30. The read-in result output method according to claim 27, wherein the processor or the hardware further executes:
generating a second algorithm for generating, based on the set output format, information complying with the set output format from the read-in results of items identified in the identifying; and
in the outputting, the information to be outputted to the predetermined output destination device is generated according to the second algorithm.

31. The read-in result output method according to claim 30, wherein the processor or the hardware further executes:
securing a predetermined storage area in the memory for storing identification information of an item and the read-in result of the item corresponded with each other as a registration destination of the read-in result in the registering, irrespective of settings of the input format and the output format;
wherein in the identifying, the items for which the registered read-in result is to be outputted in the outputting and the necessary item are identified by the identification information of the items included in the output format; and
wherein the reading is reading, for the outputting, the read-in result of the item indicated by the identification information identified in the identifying, from the predetermined storage area.

32. The read-in result output method according to claim 26, wherein the processor or the hardware further executes:
performing, every time a read-in result is newly registered in the registering regarding an item for which a read-in result is not registered in the memory yet, a notification of the registration.

33. The read-in result output method according to claim 26, wherein the processor or the hardware further executes:
outputting, when the input information read in the reading does not match any of the set input formats, the input information to the predetermined output destination device.

34. A non-transitory machine-readable medium containing program instructions executable by a computer, and enabling the computer to control a read-in device comprising a reader configured to read information in a read-in area as input information, thereby enabling the computer and the read-in device to cooperatively execute:
reading information in a read-in area as input information;
setting input formats of information;
registering information of one or more items extracted from input information which matches one of the set input formats among the input information read in the reading, based on the one input format, as a read-in result of the one or more items in a predetermined memory, information of an item for which any read-in result is not registered in the memory, among the extracted information, being registered additively to a read-in result which has been already registered;
repeating the reading and the registering until the read-in result is registered for all necessary items;
reading, when read-in results for all necessary items are registered in the memory, the registered read-in results from the memory; and
outputting the read read-in results to a predetermined output destination device.
